(19) United States
(12) Patent Application Publication
(10) Pub. No.: US 2007/0183926 A1
(43) Pub. Date: Aug. 9, 2007

(54) Sample measuring apparatus

(75) Inventor: Eiji Tanoshima, Kobe-shi (JP)

Correspondence Address: BRINKS HOFER GILSON & LIONE, P.O. BOX 10395, CHICAGO, IL, 60610, US

(73) Assignee: Sysmex Corporation

(21) Appl. No.: 11/704,771

(22) Filed: Feb. 9, 2007

(30) Foreign Application Priority Data
Feb. 9, 2006 (JP) 2006-032752

(51) Int. Cl. G01N 35/00

(52) U.S. Cl. 422/65; 422/68.1

(57) ABSTRACT

A sample measuring apparatus comprises a sample setting unit for setting a sample specimen and a quality control sample, a dispensing unit for dispensing the sample specimen and the quality control sample set on the sample setting unit, a reaction unit for causing a reaction between the sample specimen and the quality control sample dispensed by the dispensing unit, and a control unit for controlling the dispensing unit in such a manner that, when the sample specimen and the quality control sample are set on the sample setting unit, the sample specimen is first dispensed to the reaction unit and after that, the quality control sample 1 is dispensed to the reaction unit.

This application claims priority under 35 U.S.C. §119 to Japanese Patent Application No. JP2006-032752 filed Feb. 9, 2006, the entire content of which is hereby incorporated by reference.

### FIELD OF THE INVENTION

The present invention relates to a sample measuring apparatus.

### BACKGROUND OF THE INVENTION

In the clinical examination field, specimens such as blood and urine are routinely measured by a sample measuring apparatus. Conventionally, in the clinical examination field, in order to confirm if an apparatus is operating normally and if correct reagents are used in the laboratory test, a control sample (quality control sample) with known concentration is measured to see if results of measurement of the control sample are maintained in the reference range, i.e., quality control is carried out widely. Further, to report results of measurement of the specimen (or, to confirm results of measurement of the specimen), it is necessary to confirm before reporting that results of measurement of the control sample are well maintained in the reference range. In recent years, in aging society environments, requests for examination of specimens have been increasing, and prompt processing of specimens is requested.

The timing of measurement of a control sample is greatly depending upon measurement items of the specimen and laboratory facilities. In one case, a control sample is first measured to confirm that its results are maintained in the reference range, and a specimen is then measured, or in another case, a control sample is measured whenever a predetermined number of specimens are being measured. Further, it is probable that an abnormality occurs during measurement with a measuring apparatus or measurement reagent, and in the case where the control sample is measured first, it is not possible to detect an abnormality of the measuring apparatus or measurement sample by normal results of measurements of the control sample measured by the normal measuring apparatus or measurement reagent before abnormality occurrence.

In this case, one idea is that a user sets the control sample after measurement of all specimens is completed and takes measurement for the control sample thus set. In this case, however, the user should set the control sample after measurement of the specimen, the control sample thus set be measured and it should be confirmed if measured value of the control sample is maintained within the reference range before reporting the result of measurement of the specimen. This is disadvantageous in that reporting of the result of measurement of the specimen is delayed as much as workload for setting the control sample.

To overcome this problem, conventionally, an automatic system for automatically supplying to an automatic analysis apparatus a specimen and a control sample is proposed (refer to, for example, Japanese Laid-Open Patent Publication No. 8-220104). With an automatic specimen examination system according to Japanese Laid-Open Patent Publication No. 8-220104, a quality control specimen supplying unit, which is capable of mounting a plurality of racks accommodating a quality control specimen (control sample), is provided on the way of a carrier line, and a rack accommodating the quality control specimen is automatically supplied, according to predetermined parameters, between racks accommodating general specimens (specimens) on the carrier line, to supply the general specimens and the quality control specimen to the automatic analysis apparatus. With the automatic specimen examination system disclosed by Japanese Laid-Open Patent Publication No. 8-220104, the rack accommodating the quality control specimen is supplied to the automatic analysis system at certain interval during which the general specimen is supplied to the automatic analysis apparatus (e.g., 20 racks each accommodating the general specimen are passed through the carrier line) or every monitoring time (e.g., 10 minutes after supplying of racks accommodating general specimens to the automatic analysis apparatus is interrupted), analysis is performed, and the result of measurement after analysis is reported.

However, with the automatic specimen examination system disclosed by Japanese Laid-Open Patent Publication No. 8-220104, it is necessary to provide a quality control supplying unit (sample loading unit) capable of mounting a plurality of racks accommodating the quality control specimen, or to provide a rack to be used exclusively for quality control sample, separately from the specimen supplying unit (sample loading unit) capable of mounting a plurality of racks accommodating the general specimen, and therefore, a problem arises here is that the apparatus is upsized.

### SUMMARY OF THE INVENTION

The scope of the present invention is defined solely by the appended claims, and is not affected to any degree by the statements within this summary.

The first aspect of the present invention relates to a sample measuring apparatus comprising: a sample setting unit on which a plurality of samples are capable of being set, the samples comprising a specimen and a control sample; a dispensing unit for dispensing the sample set on the sample setting unit; a measurement sample preparation unit for preparing a measurement sample by mixing the sample dispensed by the dispensing unit and a reagent; a measuring unit for measuring the measurement sample prepared by the measurement sample preparation unit; and a control unit for controlling the dispensing unit in such a manner that, when a specimen and a control sample are set on the sample setting unit, the specimen is dispensed to the measurement sample preparation unit and then the control sample is dispensed to the measurement sample preparation unit.

The second aspect of the present invention relates to a sample measuring apparatus comprising: a sample setting unit on which a plurality of samples are capable of being set, the samples comprising a specimen and a control sample; a dispensing unit for dispensing the sample set on the sample setting unit; a measurement sample preparation unit for preparing a measurement sample by mixing the sample dispensed by the dispensing unit and a reagent; a measuring unit for measuring the measurement sample prepared by the measurement sample preparation unit; and a control unit for controlling the dispensing unit in such a manner that, when a specimen and a control sample are set on the sample setting unit, the control sample is dispensed to the measurement sample preparation unit and then the specimen is dispensed to the measurement sample preparation unit, and after that, the control sample is dispensed again to the measurement sample preparation unit.

The third aspect of the present invention relates to a sample measuring apparatus comprising: a sample setting unit on which a plurality of samples are capable of being set, the samples comprising a specimen and a control sample; a dispensing unit for dispensing the sample set on the sample setting unit; a measurement sample preparation unit for preparing a measurement sample by mixing the sample dispensed by the dispensing unit and a reagent; a measuring unit for measuring the measurement sample prepared by the measurement sample preparation unit; and a control unit for controlling the dispensing unit in such a manner that, when a specimen and a control sample are set on the sample setting unit, the specimen is dispensed to the measurement sample preparation unit and then the control sample is dispensed to the measurement sample preparation unit.

### BRIEF DESCRIPTION OF THE DRAWINGS

FIG. 1 is a perspective illustration showing whole composition of a gene amplification and analysis system by a first embodiment.

FIG. 2 is a perspective illustration showing whole composition of a gene amplification measuring apparatus of the gene amplification and analysis system by the first embodiment shown in FIG. 1.

FIG. 3 is an outline plan view of FIG. 2.

FIG. 4 is a drawing showing data browser screen displayed on the display unit of personal computer composing the gene amplification and analysis system by the first embodiment shown in FIG. 1.

FIG. 5 is a drawing showing workload list screen displayed on the display unit of the personal computer composing the gene amplification and analysis system by the first embodiment shown in FIG. 1

FIG. 6 is a drawing showing analytical curve display screen displayed on the display unit of the personal computer composing the gene amplification and analysis system by the first embodiment shown in FIG. 1.

FIG. 7 is a perspective illustration showing whole composition of an immune aggregation measuring apparatus by a second embodiment.

FIG. 8 is a front view of the immune aggregation measuring apparatus by the second embodiment shown in FIG. 7.

FIG. 9 is a plan view showing internal structure of the immune aggregation measuring apparatus by the second embodiment shown in FIG. 7.

FIG. 10 is an enlarged perspective illustration of a specimen holder unit of the immune aggregation measuring apparatus by the second embodiment shown in FIG. 7.

FIG. 11 is a drawing showing aggregation reaction between antigens and antibodies binding to latex particles.

FIG. 12 is a schematic drawing of an optical detection unit of the immune aggregation measuring apparatus by the second embodiment shown in FIG. 7.

FIG. 13 is a drawing showing measurement registration screen displayed on a display unit of the immune aggregation measuring apparatus by the second embodiment shown in FIG. 7.

FIG. 14 is a drawing showing progress status screen (specimen progress status confirmation screen) displayed on the display unit of the immune aggregation measuring apparatus by the second embodiment shown in FIG. 7.

FIG. 15 is a drawing showing progress status screen (rack usage status confirmation screen) displayed on the display unit of the immune aggregation measuring apparatus by the second embodiment shown in FIG. 7.

FIG. 16 is a graph on which is depicted an analytical curve showing relationship between concentration of calibrator and aggregation degree used in the immune aggregation measuring apparatus by the second embodiment shown in FIG. 7.

FIG. 17 is a block diagram of a control unit of the immune aggregation measuring apparatus by the second embodiment shown in FIG. 7.

FIG. 18 is a flowchart showing control flow of a dispensing unit of the immune aggregation measuring apparatus by the second embodiment shown in FIG. 7.

FIG. 19 is a flowchart showing measurement process of the immune aggregation measuring apparatus by the second embodiment shown in FIG. 7.

FIG. 20 is a graph showing relationship between aggregation degree and concentration of T1 measurement results and T2 measurement results.

### DETAILED DESCRIPTION OF THE EMBODIMENT

### First Embodiment

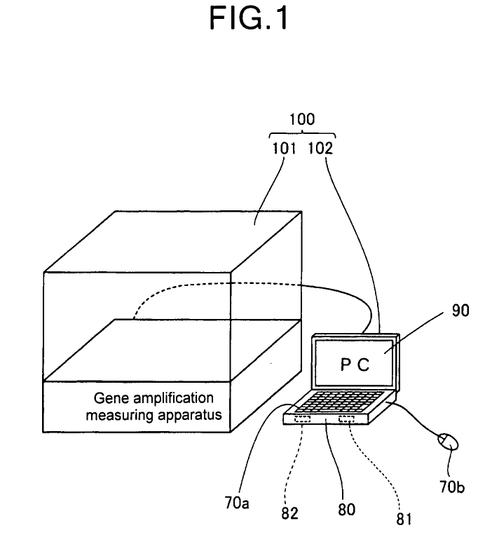

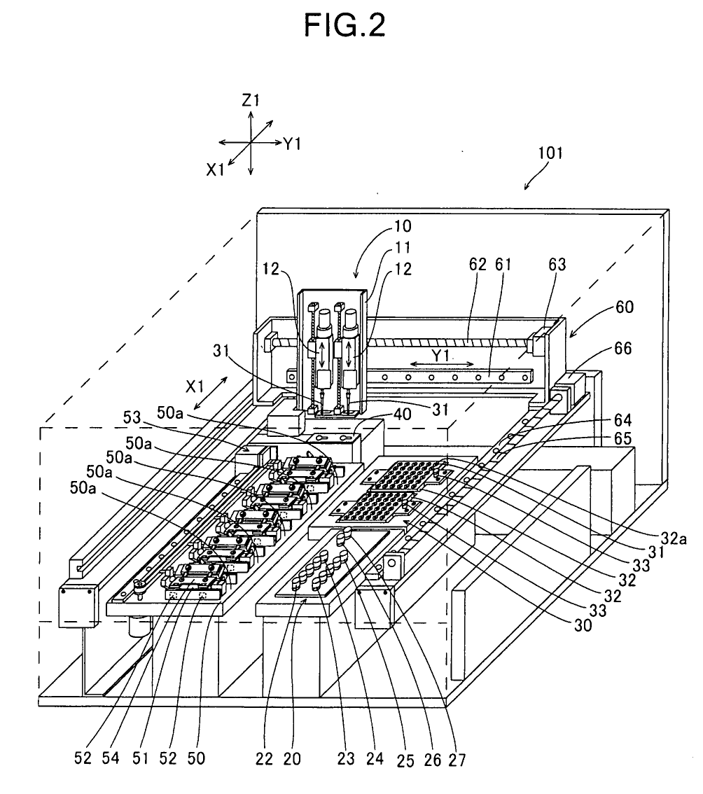

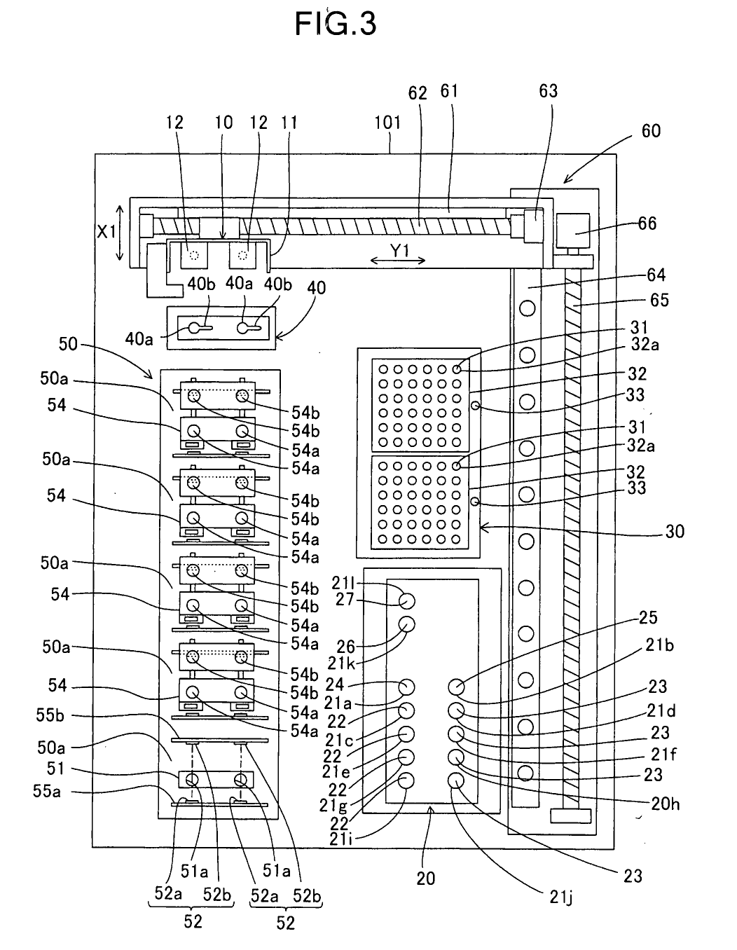

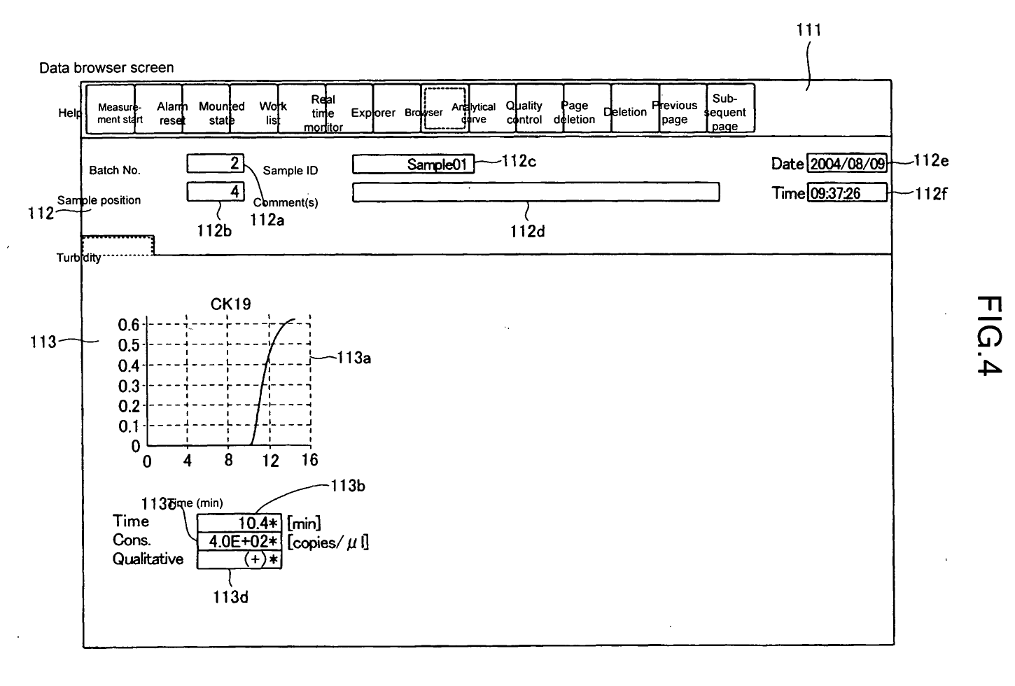

FIG. 1 is a perspective illustration showing whole composition of the gene amplification and analysis system by the first embodiment according to the present invention. FIG. 2 is a perspective illustration showing whole composition of the gene amplification measuring apparatus of the gene amplification and analysis system shown in FIG. 1, and FIG. 3 is an outline plan view of FIG. 2. FIG. 4 through FIG. 6 are drawings for explaining screen layout of the display unit of the gene amplification measuring apparatus. A gene amplification and analysis system 100 according to the first embodiment is a system supporting cancer metastasis diagnosis for resected tissue (lymph node) at operation of cancer, where target gene (mRNA) originated from cancer existing in the resected tissue is amplified by LAMP (Loop-Medicated Isothermal Amplification, Eiken Chemical Co., Ltd.), and white turbidity due to magnesium pyrophosphate, which is generated by amplification, is measured by turbidimetrical assay method to know whether or not the target gene is present at a predetermined level or more. Meanwhile, details of the LAMP method are disclosed by U.S. Pat. No. 6,410,278. Further, the gene amplification and analysis system 100 by the first embodiment is designed to report the result of measurement of a sample specimen (or to confirm the result of measurement of sample specimen) by measuring a quality control sample.

The gene amplification and analysis system 100 of the first embodiment comprises, as shown in FIG. 1, a gene amplification measuring apparatus 101 and a personal computer (PC) 102 connected so as to allow communication with the gene amplification measuring apparatus 101 in wired or wireless fashion.

First, referring to FIGS. 1 to 3, details of the gene amplification measuring apparatus 101 will be explained. The gene amplification measuring apparatus 101 includes, as shown in FIGS. 2 and 3, a dispensing unit 10, a sample setting unit 20, a chip setting unit 30, a chip disposal unit 40, a reaction unit 50 comprising five reaction detection blocks 50a, and a transfer unit 60 for transferring the dispensing unit 10 in X1-axis direction and Y1-axis direction.

Further, the dispensing unit 10 includes, as shown in FIGS. 2 and 3, an arm portion 11 which is moved in X1-axis direction and Y1-axis direction (horizontal direction) by a transfer unit 60, and a double (two) syringe unit 12 each capable of moving independently in Z1-axis direction (vertical direction) with regard to the arm portion 11. The dispensing unit 10 is composed so as to move between a sample setting unit 20 and the reaction unit 50.

According to the present embodiment, the sample setting unit 20 is provided to execute batch processing for every predetermined number (in the first embodiment, maximum four sample specimens and maximum four dilution samples). Here, by batch processing is meant that a predetermined number of sample specimens and dilution samples are processed collectively. As shown in FIG. 3, to this sample setting unit 20 are provided, from the front of the apparatus, ten sample container setting holes 21a through 21j, one enzyme reagent container setting hole 21k and one primer reagent container setting hole 21l. Meanwhile, ten sample container setting holes 21a through 21j are provided being arranged in five lines and two rows. And, sample container setting holes 21c and 21d, sample container setting holes 21e and 21f, sample container setting holes 21g and 21h, sample container setting holes 21i and 21j are provided to, from the back of the apparatus, sample setting position 1, sample setting position 2, sample setting position 3, and sample setting position 4, respectively.

Besides, to the sample container setting holes 21c, 21e, 21g and 21i at the left of the front, is set a sample container 22 in which solubilization extraction liquid (sample specimen), produced in advance by treatment (homogenization, filtering or the like) of a resected living tissue (lymph node), and to the sample container setting holes 21d, 21f, 21h and 21j at the right of the front, is set a sample container 23 in which each of dilution samples (ten-fold dilution) of above-mentioned sample specimens are accommodated. Specifically, a dilution sample corresponding to a sample specimen accommodated in the sample container 22 which is to be set to the sample container setting hole 21c is accommodated to a sample container 23 of the sample container setting hole 21d. Further, a dilution sample corresponding to a sample specimen accommodated in the sample container 22 which is to be set to the sample container setting hole 21e is accommodated to a sample container 23 of the sample container setting hole 21f, a dilution sample corresponding to a sample specimen accommodated in the sample container 22 which is to be set to the sample container setting hole 21g is accommodated to a sample container 23 of the sample container setting hole 21h, a dilution sample corresponding to a sample specimen accommodated in the sample container 22 which is to be set to the sample container setting hole 21i is accommodated to a sample container 23 of the sample container setting hole 21j. In other words, two samples (sample specimen, dilution sample) are produced from one living tissue.

Further, to the sample container setting holes 21a is placed a container 24 in which a positive control for confirming that a gene to be amplified is amplified normally is accommodated and at the same time, to the sample container setting holes 21b is placed container 25 in which a negative control for confirming that a gene not to be amplified is not amplified normally is accommodated.

To an enzyme reagent container setting hole 21k and to a primer reagent container setting hole 21l are set an enzyme reagent container 26 accommodating an enzyme reagent of cytokeratin 19 (CK19) and a primer reagent container 27 accommodating primer reagent of CK19, respectively.

Further, as shown in FIG. 3, two racks 32 each having an accommodation hole 32a capable of accommodating 36 pieces of pipette chips 31 are inserted detachably into the chip setting unit 30. Two removal buttons 33 are provided to the chip setting unit 30. By pressing the removal button 33, racks 32 are put into removable state.

As shown in FIG. 3, two chip disposal holes 40a for disposal of used pipette chip 31 is provided to the chip disposal unit 40. Besides, a groove portion 40b having a width narrower than the chip disposal hole 40a is provided to be continued to the chip disposal hole 40a.

Further, as shown in FIGS. 2 and 3, each of reaction detection blocks 50a of the reaction unit 50 comprises a reaction unit 51, two turbidity detection units 52 and a cover closing mechanism 53 (see FIG. 3). As shown in FIG. 3, to the reaction unit 51 provided to each of reaction detection blocks 50a are provided two detection cell setting holes 51a for setting a detection cell 54. Each of the reaction detection blocks 50a is disposed to, from the back of the apparatus, cell setting position 1, cell setting position 2, cell setting position 3, cell setting position 4, and cell setting position 5.

The turbidity detection units 52 comprise, as shown in FIG. 3, an LED light source 52a comprising blue LED having 465 nm wavelength which is mounted to a substrate 55a disposed at one side face of the reaction unit 51, and a photodiode light receiving unit 52b which is mounted to a substrate 55b disposed to other side face of the reaction unit 51. Two sets of turbidity detection units 52 each comprising one LED light source 52a and one photodiode light receiving unit 52b are disposed to each of reaction detection blocks 50a. Therefore, the turbidity detection unit 52 comprising a total ten sets of LED light sources 52a and photodiode light receiving units 52b is disposed to five reaction detection blocks 50a. The LED light source 52a and the photodiode light receiving unit 52b corresponding thereto are disposed so that a light approximately 1 mm in the diameter is irradiated from the LED light source 52a to lower part of the detection cell 54 and this light could be received by the photodiode light receiving unit 52b. With the use of intensity of the light received by the photodiode light receiving unit 52b, presence or absence of the detection cell 54 can be detected and turbidity of the liquid accommodated inside of the cell unit 54a of the detection cell 54 can be monitored by a display unit 90 of the personal computer 102, which will be described later. Specifically, when the detection cell 54 is set to the detection cell setting hole 51a, since the detection cell 54 is being disposed between the LED light source 52a and photodiode light receiving unit 52b, a light received by the photodiode light receiving unit 52b becomes weaker than the case where the detection cell 54 is not set. It is now possible to detect that the detection cell 54 is being set.

The detection cell 54 has two cell units 54a for accommodating the sample specimen and dilution sample, and two cover units 54b for covering two cell units 54a.

The transfer unit 60 includes, as shown in FIGS. 2 and 3, a direct operation guide 61 and a ball screw 62 for transferring the dispensing unit 10 in Y1-axis direction, a stepping motor 63 for driving the ball screw 62, a direct operation guide 64 and a ball screw 65 for transferring the dispensing unit 10 in X1-axis direction, a stepping motor 66 for driving the ball screw 65. Transfer of the dispensing unit 10 in X1-axis direction and in Y1-axis direction is performed by turning the ball screw 62 and 65 by the stepping motor 63 and 66, respectively.

The personal computer 102 includes, as shown in FIG. 1, a keyboard 70a and a mouse 70b serving as the input device, a control unit 80 comprising a CPU 81 and a memory 82, and a display unit 90 comprising a monitor.

Next, referring to FIG. 1 and FIGS. 4 to 6, details of screen layout of the display unit 90 of the personal computer 102 will be explained. The display unit 90 (see FIG. 1) is provided to display a screen (data browser screen) for displaying measurement results of the sample specimen being measured by gene amplification measuring apparatus 101, a screen (workload list screen) for giving measurement instructions such as registration of sample ID of the sample specimen and quality control sample using the keyboard 70a and mouse 70b, and a screen (analytical curve display screen) for displaying the analytical curve, or the like.

On the data browser screen, as shown in FIG. 4, a tool bar 111 on which buttons for executing various functions such as help function are displayed, a sample information display unit 112 for displaying various information of the sample specimen, and a measurement result display unit 113 for indicating measurement results of the sample specimen which are displayed on the sample information display unit 112, are displayed.

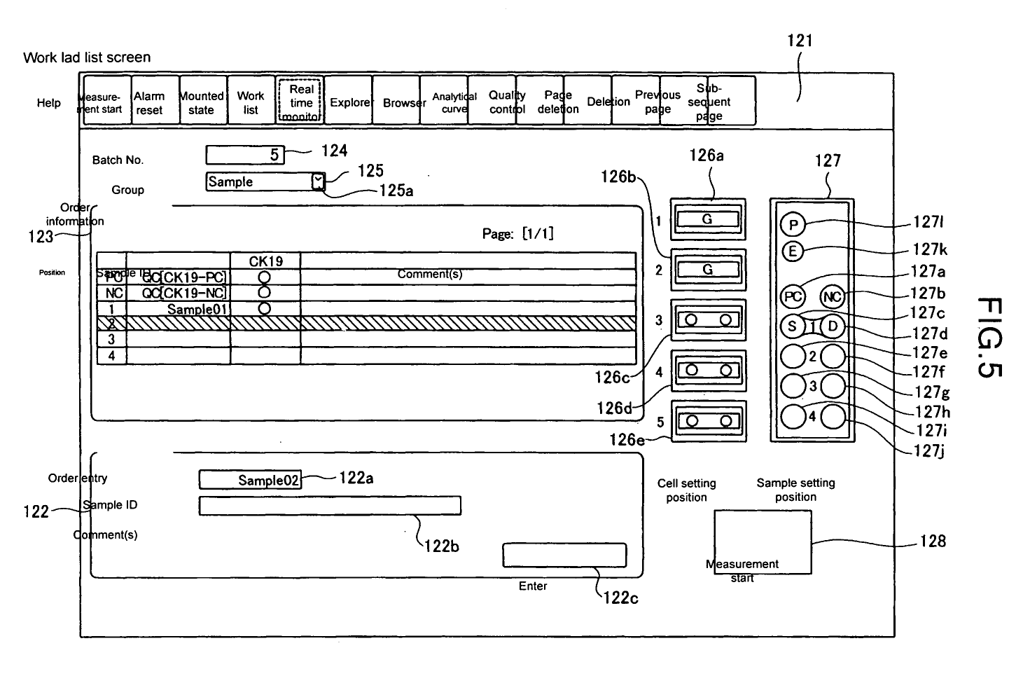

On the sample information display unit 112 are provided a batch number display column 112a, a sample position display column 112b, a sample ID display column 112c, a comment display column 112d, a measurement date display column 112e, and a measurement time display column 112f. The batch number display column 112a shows what number of batch processing is taking place. In the batch number display column 112a, a numeral showing the number of times of batch processing executed after power supplying plus “1” (“2” in the screen) is shown. In the sample position display column 112b, sample setting position where the sample specimen is being set (“4” in the screen) is displayed. In the sample ID display column 112c and comment display column 112d, comments for sample ID of the sample specimen entered in the workload list screen (see FIG. 5) which will be described later (“Sample 01,” on the screen) and for the sample specimen (dilution sample) (blank on the screen) are displayed, respectively. Further, in the measurement date display column 112e and measurement time display column 112f, date of measurement of the sample specimen and dilution sample (“2004/08/09” on the screen) and time (“09:37:26” on the screen) are displayed.

On the measurement result display unit 113, a graph 113a showing relationship between turbidity of the sample specimen identified from above-mentioned batch number display column 112a and sample position display column 112b and time (minute), amplification rising time display column 113b, concentration measurement display column 113c, and judgment result display column 113d are provided. In the meantime, measurement results of the dilution sample (graph, amplification rising time, concentration measurement and judgment results) are set so that users other than the administrator are not permitted to take a look. As a result, it is possible to remove such a chance that users may consider measurement result of the dilution sample as measurement result of the sample specimen.

In the amplification rising time display column 1113b, time corresponding to turbidity 0.1 on the vertical axis of the graph 113a (“10.4” on the screen) is displayed.

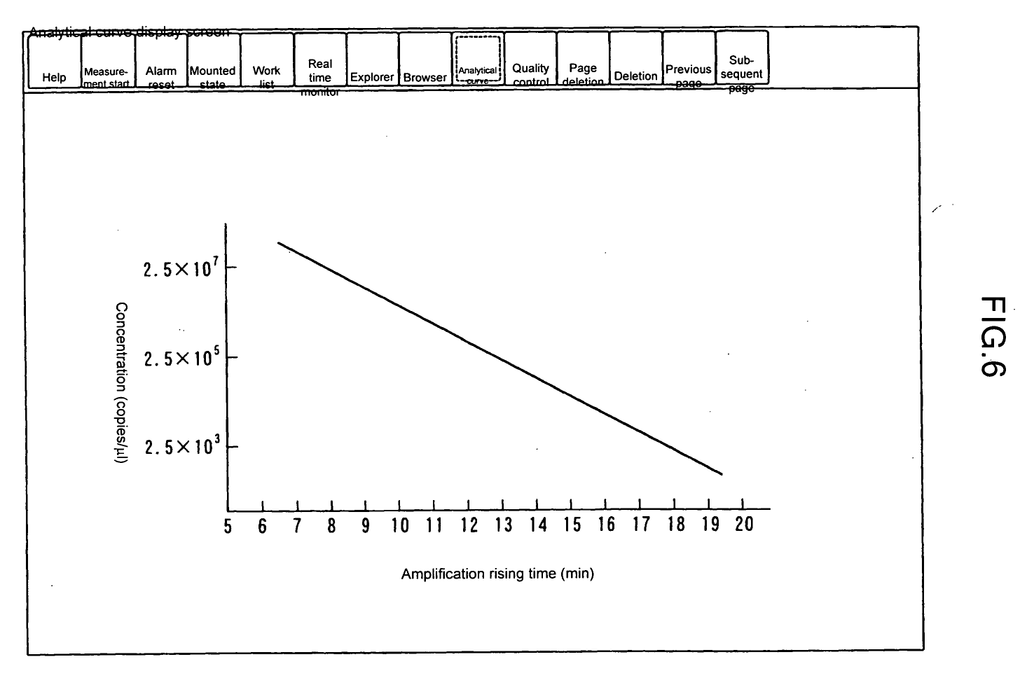

In the concentration measurement display column 113c, concentration (copies/μl) of the sample specimen calculated from the rising time (=10.4) (minute) displayed on the amplification rising time display column 113b (“4.0E+02” on the screen) is displayed. Specifically, concentration is calculated from amplification rising time (=10.4) based on the analytical curve (see FIG. 6) that is a linear function of amplification rising time and concentration prepared by a calibrator measured in advance. Since concentration detection limit of the gene amplification measuring apparatus 101 of the first embodiment is 2.5×10² (copies/μl), a concentration less than 2.5×10² (copies/∥l) is displayed as “<2.5E+02”.

The judgment result display column 113d is provided to display the result of whether or not a target gene (mRNA) is present in the sample specimen at a predetermined amount or more (positive “+”, negative “−”) based on the measurement result (concentration) of the sample specimen, and the measurement result (concentration) of dilution sample thereof.

On the workload list screen, as shown in FIG. 5, a tool bar 121 on which buttons for executing various functions such as printing function are displayed, an order entry unit 122 for entering measurement order (measurement indication), an order list display unit 123 for displaying status of measurement order registration, a batch number display column 124, a group selection column 125, cell setting position display units 126a to 126e, a sample setting position display unit 127, and a measurement start button 128 are displayed.

Further, the order entry unit 122 is provided to execute entry of measurement order for sample setting positions 1 to 4, and entry of measurement order for the quality control sample (positive control, negative control) to be set to the sample container setting holes 21a and 21b (see FIG. 3). To this order entry unit 122 are provided a sample ID entry column 122a, a comment entry column 122b and an enter button 122c. Specifically, using the keyboard 70a, sample ID is entered to the sample ID entry column 122a for sample specimen at sample setting positions 1 to 4, and quality control sample of sample container setting holes 21a and 21b. As for the sample ID, ID corresponding to negative control and positive control as well as ID corresponding to the sample ID is entered. As for ID of a sample, for example, “Sample 01˜Sample 04” are used. As for sample ID of positive control, for example, “QC [CK19-PC]” is used. As for sample ID of negative control, for example, “QC [CK19-NC]” is used. When there is a comment(s) for sample specimen and quality control sample (positive control, negative control), it is possible to enter the comment to the comment entry column 122b of the order entry unit 122. When the enter button 122c is clicked by the mouse 70b, the sample ID and comment(s) being entered are reflected to the order list display unit 123.

The batch number display column 124 displays what number of batch processing is taking place in similar fashion as the batch number display column 112a of the sample information display unit 112 of data browser screen (see FIGS. 4 to 6). In the group selection column 125, a group is selected from a pulldown menu 125a. As for this group, for example, a group for measuring sample specimen, a group for measuring calibrator for obtaining an analytical curve, and the like are mentioned. The first embodiment shows the case where the group for measuring a sample specimen (Sample) is selected. When this group (Sample) is selected, “0” is displayed at a place corresponding to CK19 on the order list display unit 123.

Further, cell setting position display units 126a to 126e are provided to display set status of the detection cell 54 of each of reaction detection blocks 50a of the reaction detection unit 50. As for set status of the detection cell 54, when use is scheduled and the detection cell 54 is set to the detection cell setting hole 51a, “G” (displayed in green) is displayed on the cell setting position display units 126a and 126b, as shown in FIG. 5. When the detection cell 54 is not set to the detection cell setting hole 51a although use is scheduled, “NG” (displayed in red) is displayed at a predetermined place of the cell setting position display units 126a to 126e. When setting of the detection cell 54 to the detection cell setting hole 51a is not required since use is not scheduled, a pattern (displayed in grey) showing the reaction unit 51 in a state, that there is no need for setting the detection cell 54 at a predetermined position (cell setting position display units 126c to 126e in FIG. 5) of the cell setting position display units 126a to 126e, is displayed.

The sample setting position display unit 127 is provided to display set status of the sample container 22 for accommodating a sample specimen of the sample setting unit 20 of the gene amplification measuring apparatus 101, the sample container 23 for accommodating dilution sample, the container 24 for accommodating positive control, the container 25 for accommodating negative control, the enzyme reagent container 26, and the primer reagent container 27. The sample setting position display unit 127 has sample container display units 127a to 127j corresponding to ten sample container setting holes 21a to 21j, an enzyme reagent container display unit 127k corresponding to the enzyme reagent container setting hole 21k, and a primer reagent container display unit 127l corresponding to the primer reagent container setting hole 21l. Alphabets (“PC” on the screen) corresponding to sample ID (QC “CK19-PC”) displayed on the order list display unit 123 are displayed on the sample container display unit 127a. Besides, alphabets (“NC” on the screen) corresponding to sample ID (QC “CK19-NC”) displayed on the order list display unit 123 are displayed on the sample container display unit 127b.

Further, an alphabet (“S” showing sample on the screen) corresponding to sample ID displayed on the order list display unit 123 is displayed on the sample container display units 127c, 127e, 127g and 127i. An alphabet (“D” showing dilution on the screen) showing a dilution sample is displayed on sample container display units 127d, 127f, 127h and 127j. On the enzyme reagent container display unit 127k is displayed an alphabet (“E” on the screen) showing that the enzyme reagent container 26 is being set, and on the primer reagent container display unit 127l is displayed an alphabet (“P” on the screen) showing that the primer reagent container 27 is placed. In the first embodiment, a screen showing that entry of measurement order for sample setting position 1 has been completed is shown.

The analytical curve display screen is, as shown in FIG. 6, a screen for displaying an analytical curve prepared by measuring calibrator of three known concentrations (2.5×10³ (copies/μl), 2.5×10⁵ (copies/μl), 2.5×10⁷ (copies/μl)), and three concentration points plotted against calibrator rising amplification time are represented by a straight line approximated by linear expression.

The control unit 80 (see FIG. 1) has a function to control the gene amplification measuring apparatus 101 which takes measurement of the sample specimen and dilution specimen, and quality control sample (positive control, negative control).

According to the first embodiment, the CPU 81 of the control unit 80 has a function to control the dispensing unit 10 so that, after all sample specimens (dilution sample), which are set on the sample setting unit 20 and are to be subjected to batch processing, are dispensed to the cell unit 54a of the detection cell 54 to be set to the reaction unit 50, quality control samples (positive control, negative control) are being dispensed consecutively to the cell unit 54a of the detection cell 54 to be set to the reaction unit 50. Specifically, the CPU 81 first controls the dispensing unit 10 so that sample specimen and dilution sample to be set to the sample setting position 1 are dispensed to cell unit 54a of the detection cell 54 to be set to the reaction detection block 50a at the cell setting position 1, and following this, the CPU 81 controls the dispensing unit 10 so that sample specimen and dilution sample to be set to the sample setting position 2 are dispensed to cell unit 54a of the detection cell 54 to be set to the reaction detection block 50a at the cell setting position 2. Then, the CPU 81 controls the dispensing unit 10 so that sample specimen and dilution sample to be set to the sample setting position 3 are dispensed to cell unit 54a of the detection cell 54 to be set to the reaction detection block 50a at the cell setting position 3, and following this, the CPU 81 controls the dispensing unit 10 so that sample specimen and dilution sample to be set to the sample setting position 4 are dispensed to cell unit 54a of the detection cell 54 to be set to the reaction detection block 50a at the cell setting position 4. After that, the CPU 81 controls the dispensing unit 10 so that the quality control sample (positive control, negative control) to be set to the sample container setting holes 21a and 21b of the sample setting unit 20 (see FIG. 3) are dispensed to cell unit 54a of the detection cell 54 to be set to the reaction detection block 50a at the cell setting position 5.

Further, the CPU 81 has a function to analyze results of measurement (concentration) of the quality control sample (positive control, negative control) measured by the gene amplification measuring apparatus 101, and judges whether or not the results of measurement (concentration) of the quality control sample obtained is within a predetermined range. Specifically, the CPU 81 judges whether or not the results of measurement (concentration) of the positive control from 9.0 minutes to 13.0 minutes after the measurement is 5.0×10² (copies/μl) or more and 5.0 10⁴ (copies/μl) or less. The CPU 81 also judges whether or not the results of measurement (concentration) of the negative control 16.0 minutes after the measurement is 0 or more and 2.5×10² (copies/μl) or less. The CPU 81 also has a function to control the display unit 90 so that measurement results of the sample specimen and dilution sample are displayed, based on the judgment result of the quality control sample mentioned above. Specifically, when the results of measurement (concentration) of the quality control sample (positive control, negative control) are outside the predetermined range, the CPU 81 attaches a flag “*” to the results of measurement of a sample specimen in the batch concerned and causes the display unit 90 to display the result on the data browser screen (see FIG. 5) showing that there is “quality control abnormality” with that result.

According to the first embodiment, positions of the sample container 22 accommodating sample specimen to be set on the sample setting unit 20, the sample container 23 accommodating dilution sample, the container 24 accommodating the positive control, and the container 25 accommodating the negative control are stored in the memory 82 in the control unit 80. Specifically, when a user enters, on the workload list screen (see FIG. 5), using the keyboard 70a, sample ID of sample specimens (dilution samples) at sample setting positions 1 to 4 and sample ID of the quality control sample of the sample setting unit 20 into the sample ID entry column 122a, positions of the sample specimen (dilution sample) and quality control sample in the sample setting unit 20 are stored in the memory 82.

Next, referring to FIGS. 1 to 6, operations of the gene amplification and analysis system 100 according to the first embodiment will be explained. With the gene amplification and analysis system 100 according to the first embodiment, as mentioned above, a target gene (mRNA) derived from a cancer which is present in a tissue resected at cancer operation is amplified using LAMP method, white turbidity due to magnesium pyrophosphate generated by amplification is measured to make judgment whether or not the target gene exists at the predetermined amount or more.

First, as shown in FIGS. 2 and 3, the sample containers 22, in which a solubilization extraction liquid (sample specimen) produced in advance by treatment (homogenization, filtering or the like) of the resected tissue is accommodated, are set to the sample container setting holes 21c, 21e, 21g and 21i. According to the first embodiment, the sample containers 23 accommodating the dilution samples (sample specimen to be accommodated in the sample container 22 is diluted ten-fold) are set to the sample container setting holes 21d, 21f, 21h and 21j. The container 24 in which positive control is accommodated and the container 25 in which negative control is accommodated are set to the sample container setting holes 21a and 21b, respectively (see FIG. 3). The enzyme reagent container 26 in which enzyme reagent of CK19 is accommodated and the primer reagent container 27 in which primer reagent of CK19 is accommodated are set to the enzyme reagent container setting hole 21k (see FIG. 3) and the primer reagent container setting hole 21l, respectively. Further, two racks 32 each accommodating 36 pieces of disposable pipette chips 31 are set in the chip setting unit 30.

Before starting measurements, measurement instructions such as registration of sample ID are given on the screen of the display unit 90 of the personal computer 102 (workload list screen (see FIG. 5)) using the keyboard 70a and mouse 70b of the personal computer 102 shown in FIG. 1. With these manipulations, according to the first embodiment, positions of the sample specimen (dilution sample) and quality control sample in the sample setting unit 20 are stored in the memory 82 of the control unit 80.

The user then clicks, using the mouse 70b (see FIG. 1), the measurement start button 128 on the workload list screen shown in FIG. 5. With this manipulation, measurement operations of the gene amplification measuring apparatus 101 are started.

When operations of the gene amplification measuring apparatus 101 are started, first, the arm portion 11 of the dispensing unit 10 is moved from initial position to the chip setting unit 30 by the transfer unit 60 shown in FIG. 2, and then, at the chip setting unit 30, two syringe units 12 of the dispensing unit 10 are moved downwardly. By these operations, front edge of nozzle part of two syringe units 12 are press fit into upper opening of two pipette chips 31 and therefore, the pipette chip 31 is automatically mounted to front edge of nozzle part of two syringe units 12. After two syringe units 12 are moved upwardly, the arm portion 11 of the dispensing unit 10 is moved in X1-axis direction towards upper part of the primer reagent container 27 in which primer reagent of CK19 is accommodated. After one syringe unit 12 located at upper part of the primer reagent container 27 is moved downwardly and primer reagent is sucked, that syringe unit 12 is then moved upwardly. After that, the arm portion 11 of the dispensing unit 10 is moved in Y1-axis direction by the transfer unit 60 so that the other syringe unit 12 may be located at upper part of the primer reagent container 27. After the other syringe unit 12 is moved downwardly and primer reagent is sucked from the same primer reagent container 27, that other syringe unit 12 is moved upwardly. In this way, primer reagent of CK19 in the primer reagent container 27 is sucked by two pipette chips 31 mounted to the syringe unit 12.

After the primer is sucked and after two syringe units 12 are moved upwardly, the arm portion 11 of the dispensing unit 10 is moved by the transfer unit 60 above the reaction detection block 50a which is located at the cell setting position 1 that is the deepest (back of apparatus front). When two syringe units 12 are moved downwardly at the reaction detection block 50a which is located at the deepest, two pipette chips 31 mounted to two syringe units 12 are inserted into two cell units 54a of the detection cell 54, respectively. Following this, using the syringe unit 12, primer reagent of CK19 is discharged to two cell units 54a, respectively.

After primer reagent is discharged and after two syringe units 12 are moved upwardly, the arm portion 11 of the dispensing unit 10 is moved by the transfer unit 60 in X1-axis direction towards upper part of the chip disposal unit 40. Then, disposal of the pipette chip 31 is performed at the chip disposal unit 40. Specifically, after two syringe units 12 are moved downwardly, the pipette chip 31 is inserted into two chip disposal holes 40a (see FIG. 3) of the chip disposal unit 40. When the arm portion 11 of the dispensing unit 10 is moved by the transfer unit 60 in Y1-axis direction with this state, the pipette chip 31 is moved under the groove portion 40b. When two syringe units 12 are moved upwardly, flange portion on upper plane of the pipette chip 31 abuts lower plane at both sides of the groove portion 40b thereby receiving a downward force from the lower plane, and therefore, the pipette chip 31 are automatically disengaged from nozzle part of two syringe units 12. By these operations, the pipette chip 31 is disposed to the chip disposal unit 40.

Next, the arm portion 11 of the dispensing unit 10 is moved again by the transfer unit 60 to the chip setting unit 30. Following this, at the chip setting unit 30, two new pipette chips 31 are automatically mounted to front edge of the nozzle part of two syringe units 12 by the same operations as mentioned above. The arm portion 11 of the dispensing unit 10 is moved in X1-axis direction towards upper part of the enzyme reagent container 26 in which enzyme reagent of CK19 is accommodated. After one syringe unit 12 located at upper part of the enzyme reagent container 26 is moved downwardly and enzyme reagent is being sucked, that one syringe unit 12 is moved upwardly. Following this, the arm portion 11 of the dispensing unit 10 is moved by the transfer unit 60 in Y1-axis direction so that the other syringe unit 12 may be located at upper part of the same enzyme reagent container 26. After the other syringe unit 12 is moved downwardly and enzyme reagent is being sucked from the same enzyme reagent container 26, that other syringe unit 12 is moved upwardly. In this way, enzyme reagents in the enzyme reagent container 26 are sucked by two pipette chips 31 mounted to the syringe unit 12.

After the arm portion 11 of the dispensing unit 10 is moved by the transfer unit 60 above the reaction detection block 50a which is located at the deepest, enzyme reagent of CK19 is discharged to two cell units 54a of the detection cell 54. After the enzyme reagent is discharged, and after the arm portion 11 of the dispensing unit 10 is moved by the transfer unit 60 above the chip disposal unit 40, disposal of the pipette chip 31 is performed.

Next, the arm portion 11 of the dispensing unit 10 is moved again by the transfer unit 60 to the chip setting unit 30, and two new pipette chips 31 are automatically mounted to front edge of the nozzle part of two syringe units 12. The arm portion 11 of the dispensing unit 10 is moved in X1-axis direction towards upper part of the sample container 22 and sample container 23 in which the sample specimen and dilution sample being set to the sample setting unit 20 are accommodated, and after that, the sample specimen and dilution sample in the sample containers 22 and 23 are sucked at once by the same suction operations of primer reagent and enzyme reagent as mentioned above. After that, the arm portion 11 of the dispensing unit 10 is moved by the transfer unit 60 above the reaction detection block 50a located at the deepest, and then two syringe units 12 are moved downwardly, and the sample specimen and dilution sample are discharged to two cell units 54a of the detection cell 54, respectively. Meanwhile, when dispensing primer reagent, enzyme reagent and sample specimen (dilution sample), temperature of liquid in the detection cell 54 is held at approximately 20° C. Following this, the arm portion 11 of the dispensing unit 10 is moved by the transfer unit 60 above the chip disposal unit 40, and then disposal of the pipette chip 31 is performed.

After primer reagent, enzyme reagent, sample specimen and dilution sample are discharged into cell unit 54a as mentioned above, cover closing operation of the cover unit 54b of the detection cell 54 is performed. After cover closing operation is completed, temperature of liquid in the detection cell 54 is heated from approximately 20° C. to approximately 65° C. to allow amplification of target gene (mRNA) by LAMP (gene amplification) reaction. Then, white turbidity due to magnesium pyrophosphate generated by amplification is detected by turbidimetrical assay method. Specifically, detection of turbidity is carried out by detecting (monitoring) turbidity in the detection cell 54 at amplification reaction using LED light source 52a and photodiode light receiving unit 52b shown in FIG. 3.

On this occasion, the CPU 81 of the personal computer 102 displays the graph 113a showing a relationship between reaction time (minute) and turbidity on the data browser screen of the display unit 90 as shown in FIG. 4. Then, the CPU 81 displays time corresponding to turbidity 0.1 on the vertical axis of the graph 113a on the amplification rising time display column 113b. Then, the CPU 81 causes the concentration measurement display column 113c to display concentration of the sample specimen calculated from amplification rising time and analytical curve (see FIG. 6).

As mentioned above, detection of a target gene (mRNA) at the reaction detection block 50a located at the deepest (cell setting position 1) is performed and at the same time, the result of measurement is displayed on the display unit 90. Besides, for reaction detection blocks 50a second to fourth from the deepest (cell setting positions 2 to 4), operations similar to target gene detection operations at the reaction detection block 50a at the cell setting position 1 are carried out in series.

According to the first embodiment, after measurements of the sample specimen and dilution sample are performed, at the reaction detection block 50a located at the fifth from the deepest (which is located at the cell setting position 5), measurements of the positive control in the container 24 being set to the sample container setting hole 21a of the sample setting unit 20 and the negative control in the container 25 being set to the sample container setting hole 21b are carried out in similar fashion as target gene detection operation at the reaction detection block 50a at cell setting position 1 mentioned above. In other words, in the first embodiment, the quality control sample (positive control, negative control) is measured after batch processing for measuring a maximum four sample specimens collectively is performed. With this consideration, it is confirmed, based on measurement results of the quality control sample, whether or not measurement results of the sample specimen in the batch processing are normal. When measurements results of the quality control sample are normal, measurements results of the sample specimen are reported (confirmed), and when measurements results of the quality control sample are abnormal, a flag “*” is put to measurement results of the sample specimen before reporting.

As mentioned above, operations of the gene amplification and analysis system 100 are completed by executing the batch processing as many as the predetermined number of times.

According to the first embodiment, when the sample setting unit 20 capable of setting four sample specimens (dilution sample) and quality control sample is set, and sample specimen and dilution specimen and quality control sample (positive control, negative control) are set on the sample setting unit 20, the control unit 80 for controlling the dispensing unit 10 is provided to serve in such a manner that, all (maximum four) sample specimens subjected to batch processing and dilution sample are first dispensed to the detection cell 54 to be set to the reaction unit 50, and then quality control sample is dispensed to the detection cell 54 to be set to the reaction unit 50, and then four sample specimens (dilution sample) and quality control sample may be set on the same sample setting unit 20. With this consideration, after all sample specimens subjected to batch processing and dilution samples are dispensed to the detection cell 54, it is possible to dispense the quality control samples consecutively to the detection cell 54. With these operations, after all sample specimens subjected to batch processing and dilution samples are measured, the quality control samples can be measured consecutively. As a result, measurement results of the quality control sample necessary for reporting of the sample specimen can be obtained without delay after measurement of the sample specimen, and it is possible to report promptly measurement results of the sample specimen.

According to the first embodiment, if the quality control sample is measured after all sample specimens subjected to batch processing and dilution samples are measured, all sample specimens to be subjected to batch processing can be reported collectively by measuring the quality control sample once. As a result, compared to the case where the quality control sample is measured every time the sample specimen is measured, consumption of the quality control sample can be suppressed.

Further, according to the first embodiment, by providing the sample setting unit 20 capable of setting maximum four sample specimens (dilution sample) and quality control sample, it is possible to set the sample specimen (dilution sample) and quality control sample on the same sample setting unit 20. As a result, there is no need for providing a sample setting unit capable of setting the sample specimen (dilution sample) and a sample setting unit capable of setting the quality control sample, separately, and upsizing of the apparatus can be suppressed.

According to the first embodiment, when the memory 82, for storing position of the quality control sample to be set on the sample setting unit 20, is provided in the control unit 80, the control unit 80 can, based on the position of the quality control sample stored in the memory 82, easily control the dispensing unit 10 so as to dispense the quality control sample, after the sample specimen is dispensed.

### Second Embodiment

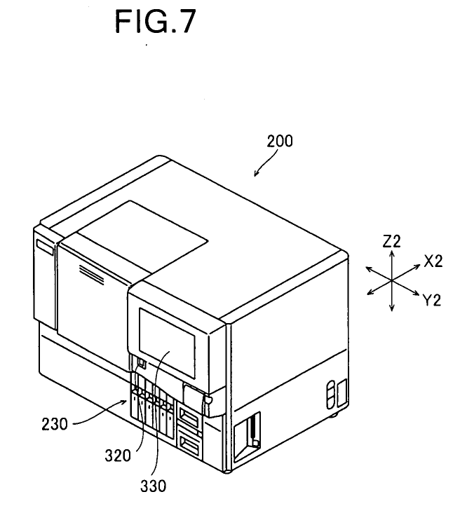

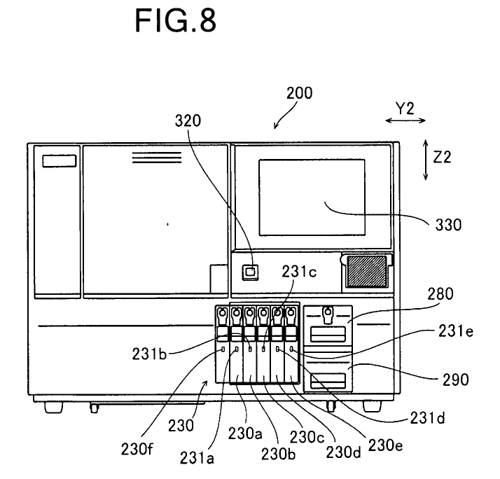

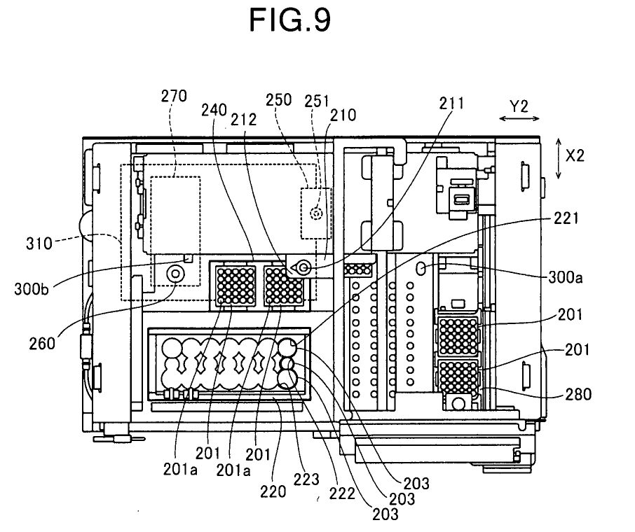

FIG. 7 is a perspective illustration showing whole composition of the immune aggregation measuring apparatus by the second embodiment, and FIG. 8 is a front view of the immune aggregation measuring apparatus shown in FIG. 7. FIGS. 9 through 17 are drawings for explaining details of the immune aggregation measuring apparatus shown in FIG. 7. A immune aggregation measuring apparatus 200 according to the second embodiment is an apparatus for measuring a small amount of proteins (antigen) in the blood by PCIA (Particle counting immuno assay). Meanwhile, whole blood or serum may be selected as the sample specimen for the sample specimen of the immune aggregation measuring apparatus 200 according to the second embodiment. The immune aggregation measuring apparatus 200 according to the second embodiment also reports measurement results of the sample specimen (whole blood or serum) (or confirms the measurement results of specimen) by measuring the quality control sample in similar fashion as the gene amplification and analysis system 100 of the first embodiment.

The immune aggregation measuring apparatus 200 according to the second embodiment includes, as shown in FIGS. 7 to 9, a dispensing unit 210, a reagent installation unit 220, a specimen holder unit 230, a reaction unit 240, a measurement dilution dispensing unit 250, a sample receiving unit 260, an optical detection unit 270, a reaction plate tray 280 for accommodating an unused reaction plate 201, a reaction plate disposal box 290 for accumulating used reaction plate 201, a washing unit 300a and 300b, a control unit 310. And, as shown in FIG. 7 and FIG. 8, a display unit 330 comprising a power switch 320 for starting the apparatus and a touch panel is provided on the front of the immune aggregation measuring apparatus 200.

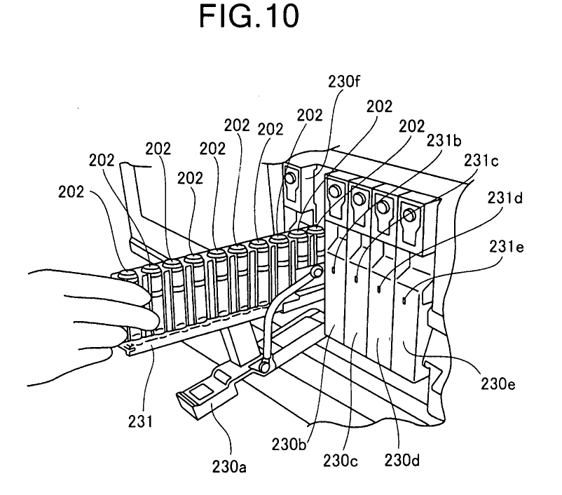

The dispensing unit 210 is composed so as to move between a rack 231 of specimen holders 230a to 230e (which will be described later) and reaction unit 240. The dispensing unit 210 includes, as shown in FIG. 9, a horizontal direction movement mechanism (not shown) capable of moving in X2-axis direction and Y2-axis direction orthogonal to horizontal direction, a specimen/latex pipette unit 211 capable of moving in vertical direction (Z2-axis direction) with regard to the horizontal direction movement mechanism, and a plate catcher unit 212. The specimen/latex pipette unit 211 has a function to dispense and to discharge a sample specimen (whole blood or serum) in a sample cup 202 (see FIG. 10) being placed in the rack 231 of the specimen holders 230a to 230e which will be described later. Further, the specimen/latex pipette unit 211 has a function to dispense and to discharge latex reagent, buffer solution and specimen dilution solution in a reagent bottle 203 to be set to the reagent installation unit 220 which will be described later. The plate catcher unit 212 is provided to transport from the reaction plate tray 280 unused reaction plate 201 to the reaction unit 240 and also to transport used reaction plate 201 to the reaction plate disposal box 290. Meanwhile, 25 cuvettes 201a capable of accommodating sample specimens and various reagents are provided to the reaction plate 201.

Further, the reagent installation unit 220 is provided to place the reagent bottle 203 accommodating buffer solution, latex reagent and specimen dilution liquid. In this case, a reagent in the reagent bottle 203 (buffer solution, latex reagent, specimen dilution liquid) is maintained at a predetermined temperature (15° C. or lower). To the reagent installation unit 220 are provided, from the back of the apparatus, a buffer solution container setting unit 221, a latex reagent container setting unit 222, and a specimen dilution liquid container setting unit 223.

Further, the specimen holder unit 230 is provided to treat all sample specimens being order registered collectively. This specimen holder unit 230 is equipped with, as shown in FIG. 10, five specimen holders 230a to 230e for setting the rack 231 capable of mounting 10 sample cups 202, and one emergency specimen holder 230f for setting the rack 231 capable of mounting one sample cup 202. And, 10 sample cups 202 can be placed on the rack 231 of the specimen holders 230a to 230e, and it is possible to set a total 50 sample cups 202 to five specimen holders 230a to 230e. Racks 231 of each of the specimen holders 230a to 230e are disposed to, from the left looking from apparatus front, rack setting position 1, rack setting position 2, rack setting position 3, rack setting position 4, and rack setting position 5. Each of sample cups 202 to be placed on racks 231 of five specimen holders 230a to 230e are disposed to, from the back of the apparatus, cup setting position 1 through cup setting position 10, respectively.

Further, one sample cup 202 accommodating the quality control sample is placed at the predetermined position of the rack 231 of specimen holders 230a to 230e of the specimen holder unit 230. On the front of five specimen holders 230a to 230e of the specimen holder unit 230 are provided specimen LED 231a to 231e, respectively (see FIG. 8 and FIG. 10). Also, an emergency specimen LED 231f is provided on the front of the emergency specimen holder 230f (see FIG. 8). These specimen LEDs 231a to 231e, and the emergency specimen LED 231f are constituted in such a manner that they light up in green when the specimen holders 230a to 230e, and the emergency specimen holder 230f are capable of being drawn, and that they light up in red when drawing is not possible. The user can then add to the rack 231 of the specimen holders 230a to 230e and to the emergency specimen holder 230f, the sample cups 202 when specimen LEDs 231a to 231e, and the emergency specimen LED 231f light up in green.

An emergency specimen sample in the sample cup 202, which is held by the rack 231 being set to the emergency specimen holder 230f, is measured, in the form of interruption, in preference to a sample specimen in the sample cup 202 which is held by the rack 231 being set to the specimen holders 230a to 230e.

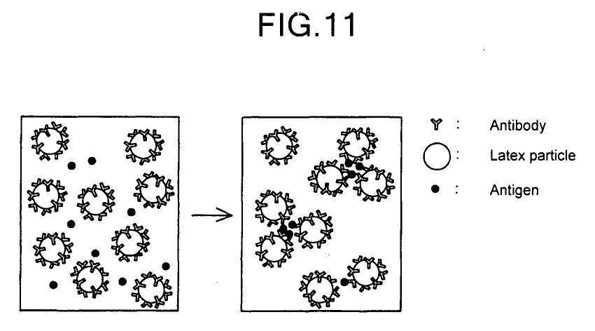

The reaction unit 240 is provided to cause a reaction between a sample specimen and an emergency specimen sample accommodated in the cuvettes 201a of two reaction plates 201, and various reagents (buffer solution, latex reagent, specimen dilution liquid). Specifically, a preparation sample is prepared by stirring and mixing a sample specimen and an emergency sample specimen being dispensed by the dispensing unit 210 as mentioned above, and various reagents (buffer solution, latex reagent, specimen dilution liquid), and by maintaining the sample specimen and the emergency sample specimen and various reagents thus stirred and mixed at a predetermined temperature, to promote aggregation reaction of the latex reagent. In other words, as shown in FIG. 11, an aggregation reaction takes place in the reaction unit 240 in such a manner that, latex particles in the latex reagents, to which antibodies are bound, aggregate using antigens in the sample specimen as the medium.

The measurement dilution dispensing unit 250 is disposed behind the dispensing unit 210 as shown in FIG. 9 and has a function to suck and to discharge the preparation sample in the cuvette 201a of the reaction plate 201 of the reaction unit 240. The measurement dilution dispensing unit 250 includes a horizontal direction movement mechanism (not shown) capable of moving in X2-axis direction and Y2-axis direction orthogonal to the horizontal direction, and a measurement dilution pipette unit 251 capable of moving in vertical direction (Z2-axis direction) with regard to the horizontal direction movement mechanism. The measurement dilution dispensing unit 250 discharges a preparation sample being sucked, which is in the cuvette 201a of the reaction plate 201, together with a measurement dilution liquid accommodated in a tank (not shown) mounted at lower part of the immune aggregation measuring apparatus 200, to the sample receiving unit 260.

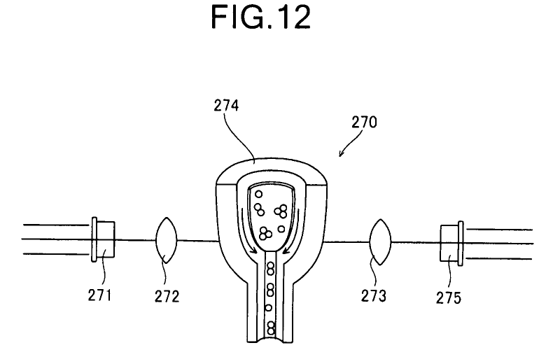

The sample receiving unit 260 is provided to receive the preparation sample in the cuvette 201a of the reaction plate 201 of the reaction unit 240 mentioned above and the measurement dilution liquid. Particle suspension (preparation sample and measurement dilution liquid) received by the sample receiving unit 260 is introduced to a sheath flow cell 274 (see FIG. 12) of the optical detection unit 270 which will be described later.

The optical detection unit 270 comprises, as shown in FIG. 12, a laser diode 271 which serves as the light source, a condenser lens 272 and a collector lens 273, a sheath flow cell 274, and a photodiode 275 which serves as the light receiving element. The sheath flow cell 274 has a function to convert a flow of particle suspension (preparation sample and measurement dilution liquid) to a flat flow by sandwiching the particle suspension by sheath liquid flow flowing both sides thereof. The composition used is such that a light irradiated to the particle suspension liquid, which flows from the laser diode 271 through the sheath flow cell 274, is scattered by aggregation clumps of latex particles in the particle suspension liquid (see FIG. 11) and is received by the photodiode 275.

The reaction plate tray 280 can accommodate maximum four unused reaction plates 201 (see FIG. 9) as shown in FIG. 7 and FIG. 8. The reaction plate 201 to be accommodated in the reaction plate tray 280 is transported by the plate catcher unit 212 of the dispensing unit 210 (see FIG. 9) to the reaction unit 240. Further, it is possible to accumulate used reaction plates 201 in the reaction plate disposal box 290, and transportation is made from the reaction unit 240 by the plate catcher of the dispensing unit 210.

The washing unit 300a is provided for washing of the specimen/latex pipette unit 211 of the dispensing unit 210. The washing unit 300b is provided for washing of the measurement dilution pipette unit 251 of the measurement dilution dispensing unit 250.

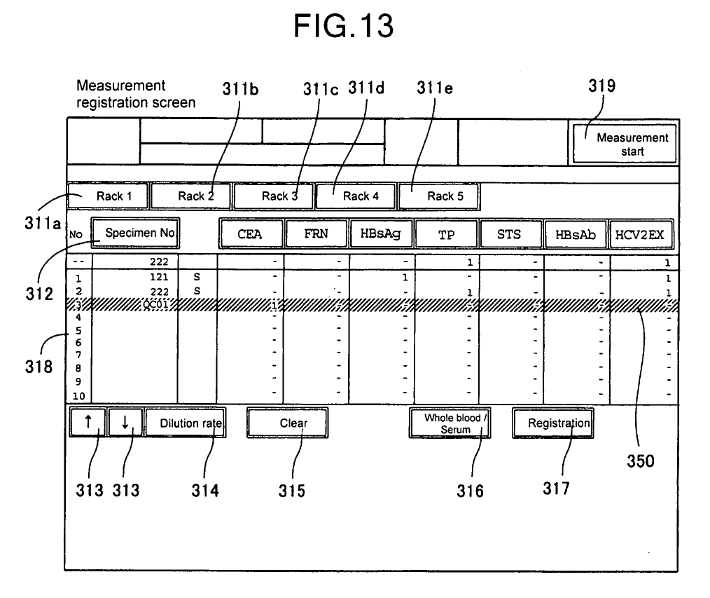

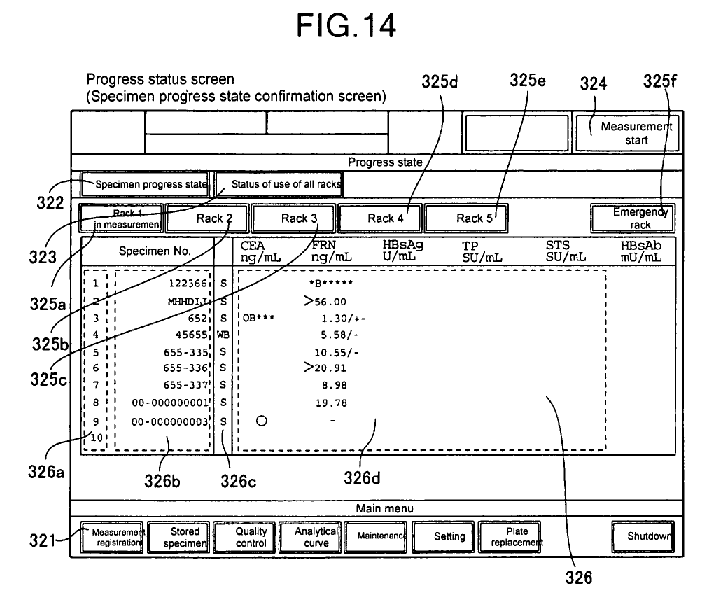

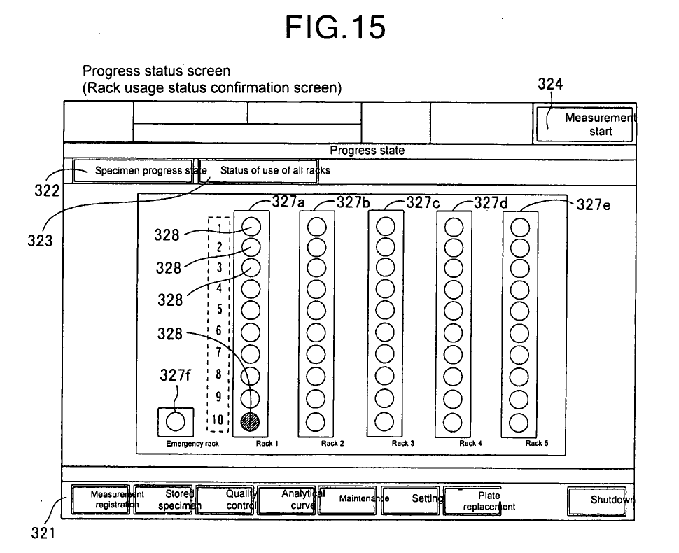

Next, referring to FIG. 7, FIG. 8 and FIGS. 10 through 16, details of screen layout of the display unit 330 will be explained. The display unit 330 (see FIG. 7) is provided for displaying a screen (progress status screen) (see FIG. 14 and FIG. 15) for displaying measurement results (concentration, flag or the like) calculated from intensity of the scattered light received by the optical detection unit 270 (see FIG. 12), a screen (measurement registration screen) (see FIG. 13) for executing measurement instructions (order registration) such as registration of sample ID of a sample specimen and quality control sample.

On the measurement registration screen are displayed, as shown in FIG. 13, five rack designation buttons 311a to 311e for designating the rack 231 of the specimen holders 230a to 230e, a specimen number input button 312 used for registration of the specimen number, cursor movement buttons 313 used for movement of the cursor 350, a dilution rate input button 314 used for registration of dilution rate, a clear key 315 for erasing of the specimen number or dilution rate once input, a whole blood/serum input button 316 for designation of type of the sample specimen (whole blood or serum), a registration button 317 for confirmation of the sample specimen (order registered) as the object of measurement (dispensing), an order list display unit 318 for display of contents of the order registration, and a measurement start button 319.

Five rack designation buttons 311a to 311e are provided for designation of the rack 231 of the predetermined specimen holders 230a to 230e of the specimen holder unit 230. For example, when the user touches the rack designation button 311a (“rack 1” on the screen), the rack 231 (see FIG. 10) to be placed on the specimen holders 230a of the specimen holder unit 230 is designated, and it is possible to execute order registration of the rack 231 to be placed on the specimen holders 230a. The specimen number input button 312 is used to input sample ID of a sample specimen and a quality control sample at cup setting positions 1 through 10 selected by the cursor 350 by touching the cursor movement button 313. As for the sample ID, in addition to ID corresponding to the sample specimen, ID corresponding to the quality control sample is input. As for ID of a sample, for example, “121 or 222” is used. As for sample ID of the quality control sample, for example, “QC01” is used. For example, when a quality control sample is accommodated in the sample cup 202 corresponding to cup setting position 3 of rack setting position 1, the user touches the rack designation button 311a to cause the order list display unit 318 to display contents of order registration of the rack setting position 1, and after that, the cursor 350 is adjusted using the cursor movement button 313 to the cup setting position 3, and registers it using the specimen number input button 312 as “QC01”.

The dilution rate input button 314 is used when dilution rate of sample specimen at cup setting positions 1 through 10, which is selected by the cursor 350, is input. The whole blood/serum input button 316 is provided for selection of types of sample specimens at cup setting positions 1 through 10, which is selected by the cursor 350. For example, “WB” is displayed when a sample specimen is whole blood and “S” is displayed when a sample specimen is serum. Contents registered by various buttons as mentioned are reflected to the order list display unit 318.

As shown in FIG. 14 and FIG. 15, on the progress status screen are displayed a main menu unit 321 on which buttons for displaying measurement registration screen (see FIG. 13) or the like are arranged, a specimen progress status display button 322 for displaying the specimen progress status confirmation screen shown in FIG. 14, a button for status of use of all racks 323 for displaying rack usage status confirmation screen shown in FIG. 15, and a measurement start button 324.

When the user touches the specimen progress status display button 322 shown in FIG. 14 and FIG. 15, the specimen progress status confirmation screen as shown in FIG. 14 is displayed. On the specimen progress status confirmation screen are displayed five rack designation buttons 325a to 325e, one emergency specimen rack designation button 325f, and a measurement result display unit 326 for displaying measurement results of the sample specimen and quality control sample.

Five rack designation buttons 325a to 325e have functions same as those of the rack designation buttons 311a to 311e on the measurement registration screen (see FIG. 13) and are provided to designate the predetermined rack 321 of the specimen holder unit 230. For example, when the user touches the rack designation button 325a (“rack 1 under measurement” on the screen), the rack 231 placed on the specimen holder 230a (see FIG. 10) of the specimen holder unit 230 is designated, and measurement results of the sample specimen and quality control sample in ten sample cups 202 to be placed on the rack 231 of the specimen holder 230a are displayed on the measurement result display unit 326. The emergency specimen rack designation button 325f is to designate the emergency specimen holder 230f of the specimen holder unit 230, and when the user touches the emergency specimen rack designation button 325f, the rack 231 to be placed on the emergency specimen holder 230f of the specimen holder unit 230 (see FIG. 8 and FIG. 10) is designated, and measurement results of the emergency specimen sample are displayed on the measurement result display unit 326.

To the measurement result display unit 326 are provided a sample position display column 326a, a sample ID display column 326b, whole blood/serum display column 326c, a result display column 326d for displaying measurement result (concentration, flag or the like) in each of measurement items. On the measurement result display unit 326 are displayed sample ID and measurement results for the rack 231 being designated by touching above-mentioned rack designation buttons 325a to 325e and the emergency specimen rack designation button 325f. In the second embodiment, the screen shown is for a case where the user touches the rack designation button 325a for designation of the rack 231 of the specimen holder 230a.

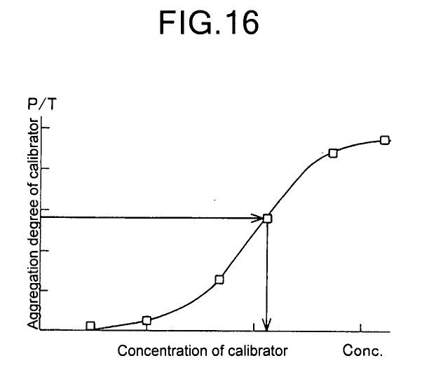

In the sample ID display column 326b is displayed sample ID corresponding to cup setting positions 1 through 10 displayed on the sample position display column 326a. This sample ID is being input in advance on the measurement registration screen (see FIG. 13). On the whole blood/serum display column 326c is displayed type of the sample specimen (e.g., whole blood: “WB”, serum: “S”) being registered using the whole blood/serum input button 316 on the measurement registration screen. On the result display column 326d is displayed concentration of the sample specimen (“>56.00”, “1.30/+” or the like) (ng/ml) which is calculated from intensity of a scattered light detected by the optical detection unit 270 mentioned above. The concentration of the sample specimen is calculated by substituting aggregation degree of latex particles (see FIG. 11) calculated from intensity of the scattered light obtained by the optical detection unit 270 (see FIG. 12) into the analytical curve (see FIG. 16) which is a function of calibrator concentration and calibrator aggregation degree prepared by the previously measured calibrator.

Further, when the user touches the button for status of use of all racks 323 shown in FIG. 14, it is possible to shift from the specimen progress status confirmation screen to the rack usage status confirmation screen which allows for confirmation of usage status of the rack 231. On the rack usage status confirmation screen are provided, as shown in FIG. 15, rack display units 327a to 327e for displaying status of the sample cup 202 to be placed on the rack 231 of each of specimen holders 230a to 230e, and an emergency specimen rack display unit 327f for displaying status of the sample cup 202 to be placed on the rack 231 of the emergency specimen holder 230f. And, each of rack display units 327a to 327e includes 10 sample cup display units 328, while the sample cup display units 328 have a function for displaying order registration status of the sample specimen and the quality control specimen in the sample cup 202. As for measurement status of the sample specimen and the quality control specimen, when an order is not registered yet, the sample cup display unit 328 is displayed in white. When the order is being registered, the sample cup display unit 328 is displayed in green. In a case the sample specimen and the quality control sample are under measurement, the sample cup display unit 328 is displayed in red. Meanwhile, FIG. 15 illustrates a case where the sample specimen at the cup setting position 10 of the rack setting position 1 is under measurement and the sample cup display unit 328 at the cup setting position 10 of the rack setting position 1 is displayed in red. FIG. 15 also shows a case where sample specimens at the position other than the cup setting position 10 of the rack setting position 1 are already order registered, and the sample cup display unit 328 at the position other than the cup setting position 10 of the rack setting position 1 is displayed in green.

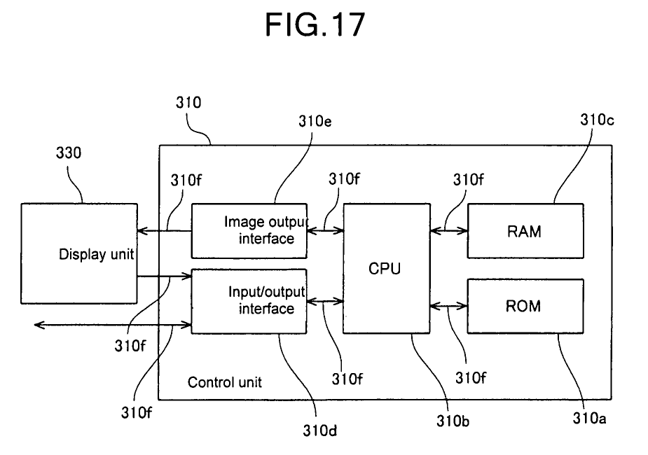

Next, referring to FIG. 12, FIG. 13 and FIG. 17, details of the control unit 310 will be explained. The control unit 310 comprises, as shown in FIG. 17, a ROM 310a, a CPU 310b, a RAM 310c, an input/output interface 310d, an image output interface 310e, and these are connected by a bus 310f to allow for data communication.

According to the second embodiment, positions of the sample cup 202 accommodating the sample specimen to be placed on the rack 231 of five specimen holders 230a to 230e of the specimen holder unit 230, and of the sample cup 202 accommodating the quality control sample are stored to the ROM 310a. Specifically, when the user inputs, on the measurement registration screen (see FIG. 13), sample ID of the sample specimen and sample ID of the quality control sample, using the specimen number input button 312 displayed on the display unit 330 (touch panel), positions of the sample specimen and the quality control sample are stored in the ROM 310a.

The CPU 310b has a function for calculation of concentration of antigens in the sample specimen from intensity of the scattered light detected by the optical detection unit 270 (see FIG. 12). Moreover, the CPU 310b has a function for analyzing measurement results (concentration) of the quality control sample being measured and judges whether or not measurement results (concentration) of the quality control sample obtained are within the normal range. This normal range is set in advance and is stored in the ROM 310a. The normal range is set by manual setting (set manually by the user) or by automatic setting set automatically by the CPU 310b. Based on judgment result of the quality control sample, the CPU 310b then reports measurement results of the sample specimen (or confirms measurement results of the sample specimen).

According to the second embodiment, the CPU 310b has a function to control the dispensing unit 210 in such a manner that, based on the position of the quality control sample stored in the ROM 310a, sample specimen in all sample cups 202, which are placed on the rack 231 of the specimen holders 230a to 230e and are order registered is dispensed to the cuvette 201a of the reaction plate 201 of the reaction unit 240, and then the quality control sample is dispensed to the cuvette 201a of the reaction plate 201 of the reaction unit 240.

The CPU 310b then controls the dispensing unit 210 to execute dispensing in series from the sample specimen in the sample cup 202 at the cup setting position 1 of the rack setting position 1 to the sample specimen in the sample cup 202 at the cup setting position 10 of the rack setting position 5. Therefore, for example, when the quality control sample is accommodated in the sample cup 202 corresponding to the cup setting position 3 of the rack setting position 1, the CPU 310b controls the dispensing unit 210 to execute dispensing of the sample specimen at the cup setting position 1 of the rack setting position 1 and the sample specimen at the cup setting position 2 of the rack setting position 1, and then to execute dispensing of the sample specimen at the cup setting position 4 of the rack setting position 1 without dispensing the quality control sample at the cup setting position 3 of the rack setting position 1. Upon completion of dispensing of all sample specimens being order registered, the CPU 310b controls the dispensing unit 210 to dispense the quality control sample at cup setting position 3 of the rack setting position 1.

According to the present embodiment, even a case where the rack 231 carrying the sample cup 202, in which the sample specimen is accommodated, is added to the specimen holder 230a to 230e, while the dispensing unit 210 is dispensing the sample specimen, the CPU 310b controls to allow for dispensing of the quality control sample to the cuvette 201a of the reaction plate 201, after the sample specimen thus added is dispensed to the cuvette 201a of the reaction plate 201. In other words, when the user, after confirming that the LEDs 231a to 231e provided on the front of the specimen holders 230a to 230e are lighted up in blue, adds the rack 231 carrying the sample cup 202 in which the sample specimen is accommodated in the specimen holders 230a to 230e thereof, the CPU 310b dispenses the quality control sample after dispensing the added sample specimen.

Further, the RAM 310c is used as the working area of the CPU 310b. Specifically, the RAM 310c is used as the working area for the CPU 310b to calculate aggregation degree and concentration from intensity of a scattered light detected by the optical detection unit 270.

The input/output interface 310d comprises, for example, a serial interface such as USB, IEEE 1394, RS-232C or the like, a parallel interface such as SCSI, IDE, IEEE 1284 or the like, and an analogue interface comprising a D/A converter, an A/D converter or the like. To the input/output interface 310d is connected the display unit 330 comprising a touch panel, and it is composed in such a manner that when the user touches the display unit 330 comprising a touch panel, a given input data is output to the CPU 310b. Besides, the image output interface 310e is connected to the display unit 330 and is composed so as to output a video signal corresponding to the image data given by the CPU 310b to the display unit 330.

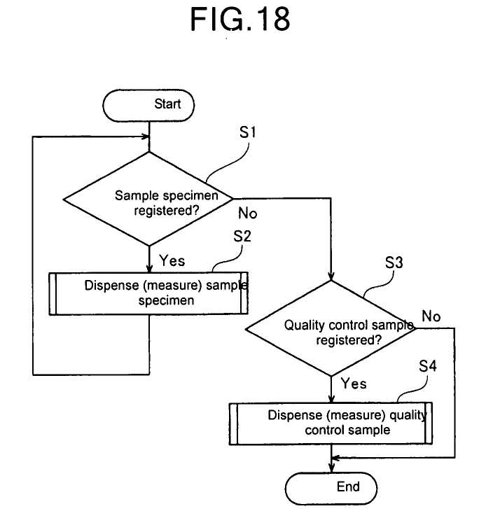

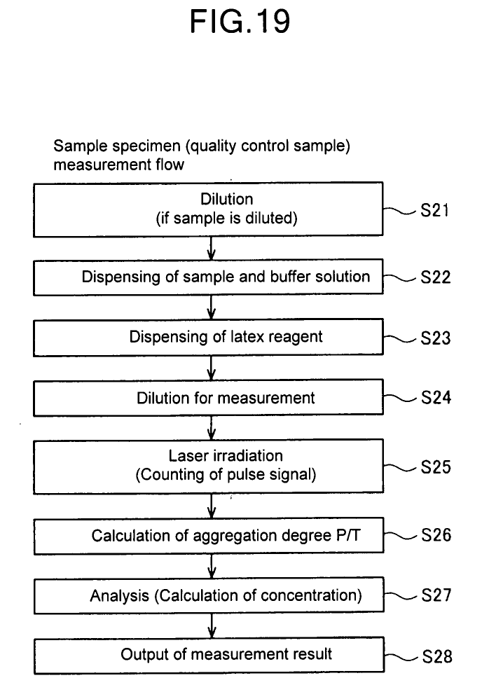

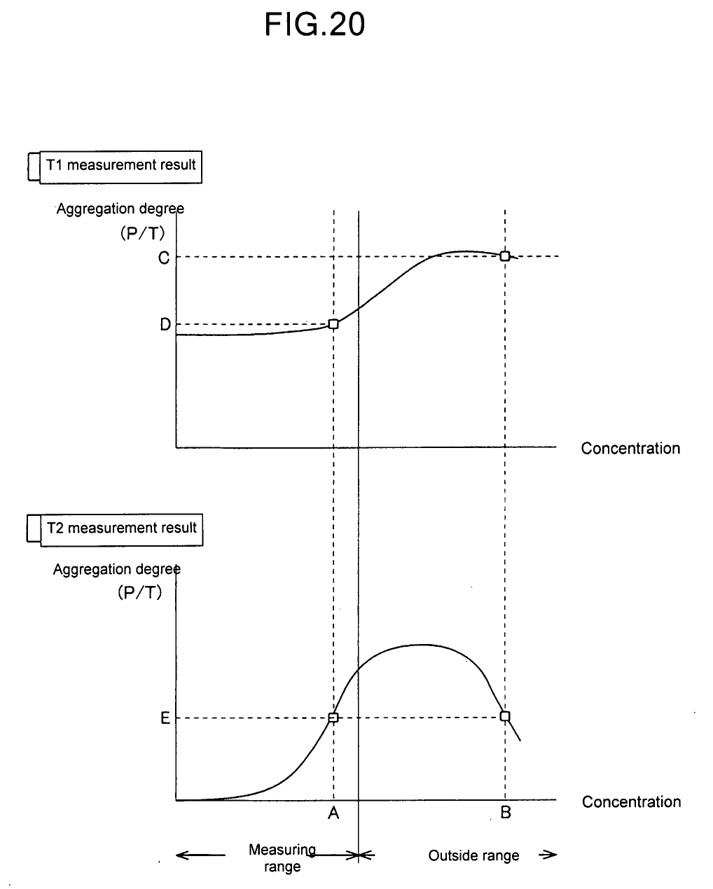

FIG. 18 is a flowchart showing control flow of the dispensing unit by the control unit of the immune aggregation measuring apparatus shown in FIG. 7. FIG. 19 is a flowchart showing measurement process of the immune aggregation measuring apparatus shown in FIG. 7. FIG. 20 is a graph showing relationship between aggregation degree and concentration of T1 measurement results and T2 measurement results.

Next, referring to FIGS. 7 through 15 and FIGS. 18 through 20, operations of the immune aggregation measuring apparatus 200 according to the second embodiment will be explained. With the immune aggregation measuring apparatus 200 according to the second embodiment, as mentioned above, aggregation degree is calculated by aggregating latex particles holding antibodies which bind to antigens in the blood (sample specimen) and by irradiating a light to aggregation clumps of aggregated latex particles, and then concentration of antigens in the blood (sample specimen) is measured from the aggregation degree.

First, as shown in FIG. 10, the sample cup 202 in which whole blood or serum (sample specimen) is accommodated is set to the rack 231 of the specimen holders 230a to 230e. Besides, one sample cup 202 accommodating the quality control sample is set to the predetermined position of the rack 231 of specimen holders 230a to 230e.

Before starting measurements, using various buttons displayed on the display unit 330 (touch panel) shown in FIG. 7 and FIG. 8, order registration of sample ID, dilution rate or the like of the sample specimen and the quality control sample is carried out on the measurement registration screen (see FIG. 13). By this operation, according to the second embodiment, positions of the sample specimen and the quality control sample are stored in the ROM 310a of the control unit 310. On this occasion, by using “QC” as sample ID of the quality control sample, position of the quality control sample is stored to the ROM 310a being distinguished from other sample specimens.

When the user touches the measurement start button 319 (see FIG. 13) or 324 (see FIG. 14 and FIG. 15), measurement operations of the immune aggregation measuring apparatus 200 start.

After operations of the immune aggregation measuring apparatus 200 are started, first, unused reaction plate 201 is transported from the reaction plate tray 280 to the reaction unit 240 by the plate catcher unit 212 of the dispensing unit 210 shown in FIG. 9.

Then, as shown in FIG. 18, in step S1, the CPU 310b of the control unit 310 of the immune aggregation measuring apparatus 200 judges whether or not there is order registration of the sample specimen. When CPU 310b judges that there is order registration of the sample specimen, in step S2, it controls the dispensing unit 210 to allow for dispensing of the sample specimen in the sample cup 202. Then, for this sample specimen, concentration is measured in the measurement process according to the flow chart shown in FIG. 19 which will be described later.

Next, in step 2, after dispensing (measurement) of the sample specimen at the cup setting position 1 of the rack setting position 1 is performed, the CPU 310b again judges in step S1 whether or not there is order registration of the sample specimen. When CPU 310b judges that there is order registration of the sample specimen, dispensing (measurement) of the sample specimen is repeated. Therefore, for example, when order registration of the quality control sample is being made to the cup setting position 3 of the rack setting position 1, sample specimens excluding the quality control sample at the cup setting position 3 of the rack setting position 1 are dispensed (measured) in series.

Again in step S1, when there is no order registration of the sample specimen, the CPU 310b judges in step S3 whether or not there is order registration of the quality control sample. When the CPU 310b judges that there is order registration of the quality control sample, in step S4, it controls the dispensing unit 210 (see FIG. 9) to allow for dispensing of the quality control sample in the sample cup 202. Then, for example, when order registration of the quality control sample is being made to the cup setting position 3 of the rack setting position 1, dispensing of the quality control sample at the cup setting position 3 of the rack setting position 1 is performed by the dispensing unit 210. Also for the quality control sample, concentration is measured in the measurement process according to the flow chart shown in FIG. 19 which will be described later.

According to the second embodiment, in a case a sample specimen is additionally order registered during dispensing operation of the sample specimen by the dispensing unit 210 (see FIG. 9), the CPU 310b dispenses and measures the added sample specimen according to the flow chart shown in FIG. 18 and then controls the dispensing unit 210 to allow for dispensing and measurement of the quality control sample. In this way, judgment is made, based on measurement results of the quality control sample, whether or not measurement results of the sample specimen are normal, measurement results of the sample specimen are reported (confirmed), thereby completing operations of the immune aggregation measuring apparatus 200.

Next, referring to FIG. 19, details of measurement process of the sample specimen and the quality control sample shown in step S2 and step S4 shown in FIG. 18 will be explained. First, as shown in FIG. 19, in step S21, when sample specimen in the sample cup 202 is diluted (dilution rate registered on the measurement registration screen is greater than 1 time), the specimen/latex pipette unit 211 of the dispensing unit 210 is moved up to the specimen dilution liquid container setting unit 223 of the reagent installation unit 220 for the sake of suction of the specimen dilution liquid. After sucking the specimen dilution liquid, the specimen/latex pipette unit 211 sucks from the sample cup 202 the sample specimen. Following this, the specimen/latex pipette unit 211 discharges the specimen dilution liquid and the sample specimen thus sucked to the cuvette 201a of the reaction plate 201 to be set to the reaction unit 240. With this manipulation, a diluted specimen is prepared in the cuvette 201a of the reaction plate 201. When no dilution is made (dilution rate registered on the measurement registration screen is 1 time) and with quality control sample, this step is omitted.

In step S22, the specimen/latex pipette unit 211 of the dispensing unit 210 is moved, after discharging the dilution specimen (specimen dilution liquid and sample specimen), up to the buffer solution container setting unit 221 of the reagent installation unit 220. The specimen/latex pipette unit 211 is moved, after sucking the buffer solution, up to the cuvette 201a in which the diluted specimen is accommodated, sucks the diluted specimen in the cuvette 201a, and then discharges the buffer solution and the diluted specimen to other cuvette 201a of the reaction plate 201. In a case of non-diluted specimen where a diluted specimen is not prepared (dilution rate registered on the measurement registration screen is 1 time), the specimen/latex pipette unit 211 is moved, after sucking the buffer solution, up to the sample cup 202, sucks sample specimen (quality control sample) in the sample cup 202, and discharges the buffer solution and the sample specimen (quality control sample) to the cuvette 201a of the reaction plate 201.

In step S23, approximately 80 sec after the diluted specimen or non-diluted specimen and buffer solution are dispensed, the specimen/latex pipette unit 211 of the dispensing unit 210 is moved up to a latex reagent container setting unit 222 of the reagent installation unit 220. The specimen/latex pipette unit 211 is moved, after sucking latex reagent, up to the cuvette 201a in which diluted specimen or non-diluted specimen and buffer solution are accommodated, and discharges in the cuvette 201a the latex reagent. With this manipulation, antigens in the sample specimen (quality control sample) and antibodies bound to latex particles in the latex reagent are bound as shown in FIG. 11, thereby starting aggregation reaction of latex particles.

Next, in step S24, approximately 20 sec after and approximately 15 minutes after the latex reagent is dispensed, the measurement dilution pipette unit 251 of the measurement dilution dispensing unit 250 is moved up to the cuvette 201a to which the latex reagent is discharged. The measurement dilution pipette unit 251 is moved, after sucking the preparation sample in the cuvette 201a (sample specimen (quality control sample), buffer solution and latex reagent), up to the sample receiving unit 260 (see FIG. 9) and discharges to the sample receiving unit 260 the preparation sample. On this occasion, the measurement dilution dispensing unit 250 discharges the measurement dilution liquid accommodated in a tank (not shown) mounted at lower part of the immune aggregation measuring apparatus 200 to the sample receiving unit 260 together with the preparation sample. Then, for the preparation sample approximately 20 sec after and approximately 15 minutes after the latex reagent is dispensed, step S25 through step S28, which will be described later, are performed to obtain aggregation degree of the preparation sample approximately 20 sec after (T1 measurement results) and aggregation degree of the preparation sample approximately 15 minutes after (T2 measurement results).

When concentration of antigens of the sample specimen is high, as shown by the graph representing T2 measurement results shown in FIG. 20, aggregation of latex particles may become weaker and appropriate concentration may not be calculated from the aggregation degree. For this reason, according to the second embodiment, in order to avoid such an instance where an inappropriate concentration is obtained due to weakened aggregation of latex particles attributable to acquisition of above-mentioned T1 measurement results and T2 measurement results, when T2 measurement results (aggregation degree) are “E”, judgment is made by T1 measurement results (aggregation degree). Specifically, when T2 measurement results (aggregation degree) are “E”, and T1 measurement results (aggregation degree) are “D”, which means that concentration A corresponding to T1 measurement results is within the measurement range, concentration is calculated from T2 measurement results (aggregation degree). On the other hand, when T2 measurement results (aggregation degree) are “E”, and T1 measurement results (aggregation degree) are “C”, which means that concentration B corresponding to T1 measurement results is outside the measurement range (range-over), if concentration is calculated exactly from T2 measurement results (aggregation degree), appropriate concentration may not be obtained. Therefore, when concentration B corresponding to T1 measurement results is outside the measurement range (outside range), dilution rate of the sample specimen is changed and the measurement is taken again.

After that, in step S25, particle suspension (preparation sample and measurement dilution liquid) discharged to the sample receiving unit 260 (see FIG. 9) is introduced to the sheath flow cell 274 of the optical detection unit 270 (see FIG. 12), and is converted to a flat flow by the sheath flow cell 274. With this state, a laser light having a wavelength of approximately 780 nm is irradiated from the laser diode 271 (see FIG. 12) to aggregation clumps of latex particles flowing through the sheath flow cell 274, and a plurality of scattered lights having intensity corresponding to the size of aggregation clumps of the latex particles are received by the photodiode 275 (see FIG. 12). On this occasion, the CPU 310b of the control unit 310 (see FIG. 17) counts each of scattered lights received by the photodiode 275 as the pulse signal.

In step S26, the CPU 310b (see FIG. 17) calculates aggregation degree, based on intensity of the scattered lights received as the pulse signal, for latex particles before aggregation and for latex particles after aggregation in discriminating fashion. Specifically, the CPU 310b judges that, when intensity of the scattered lights received is at a predetermined level or greater, aggregation clumps of latex particles that caused the scattered lights are polymer (P) (aggregated latex particles), and judges that, when intensity of the scattered lights received is less than a predetermined level, aggregation clumps of latex particles that caused the scattered lights are monomer (M) (latex particles before aggregation). The CPU 310b then calculates, using counting P of scattered lights at the predetermined level or greater and counting M of scattered lights less than the predetermined level, aggregation degree P/T of latex particles by following Equation (1).

P/T=P/(P+N) (1)

Then, in step S27, the CPU 310b converts aggregation degree P/T into concentration from the calculated aggregation degree P/T and the analytical curve prepared in advance (see FIG. 16).

Then, in step S28, the CPU 310b causes the display unit 330 to display the concentration obtained as shown in FIG. 14 and at the same time, causes the ROM 310a to store a position of the sample cup 202 of the specimen holder unit 230 (cup setting position 1 at the rack setting position 1) and the concentration in corresponding fashion. In this way, measurement process of the sample specimen at the cup setting position 1 of the rack setting position 1 is completed.

According to the second embodiment, as mentioned above, there are provided the rack 231 of the holder unit 230 capable of mounting maximum 50 pieces of samples (sample specimen and quality control sample) and the control unit 310 for controlling the dispensing unit 210 in such a manner that, when the sample cup 202 accommodating the sample specimen and the quality control sample in the rack 231 of the specimen holder unit 230 are placed, all samples order registered are dispensed first to the cuvettes 201a of the reaction plate 201 to be set to the reaction unit 240, and then the quality control sample is dispensed. With this consideration, it is possible to place the sample specimen and the quality control sample on the same holder unit 230. In this way, it is possible to dispense the quality control sample to the cuvettes 201a consecutively after all sample specimens order registered are dispensed to the cuvettes 201a. In this way, quality control samples can be measured consecutively after all sample specimens order registered are measured. As a result, it is possible to obtain measurement results of the quality control sample, which are necessary for reporting of the sample specimen, without delay after measurement of the sample specimen, and therefore, measurement results of the sample specimen can be reported promptly.

According to the second embodiment, all sample specimens order registered can be reported collectively by measuring the quality control sample once, while the quality control sample is measured after all sample specimens order registered are measured. As a result, compared to a case where the quality control sample is measured every time the sample specimen is measured, consumption of the quality control samples can be suppressed.

Further, according to the second embodiment, by providing the specimen holder unit 230 capable of placing the sample specimen and the quality control sample, it is possible to place the sample specimen and the quality control sample in the same specimen holder unit 230. As a result, there is no need for providing separately a specimen holder unit capable of placing the sample specimen (sample setting unit) and a specimen holder unit capable of placing the quality control sample (sample setting unit), and therefore, upsizing of the apparatus can be suppressed.

According to the second embodiment, even a case where other sample specimen is added to the rack 231 of the specimen holder unit 230 during dispensing operation of the sample specimen, it is possible to dispense the quality control sample in the cuvette 201a by dispensing the sample specimen, which is added after completion of dispensing of the sample specimen order registered, in the cuvette 201a of the reaction plate 201, by providing the control unit 310 which controls the dispensing unit 210 in such a manner that, when the sample cup 202 accommodating other sample specimen in the rack 231 of the specimen holder 230 is placed during dispensing operation of the sample specimen, other sample specimen is dispensed in the cuvette 201a after dispensing the sample specimen in the cuvette 201a of the reaction plate 201, and then the quality control sample is dispensed in the cuvette 201a. With this manipulation, even a case sample specimens are added in series during operations of the dispensing unit 210, it is possible to obtain measurement results of the quality control sample just after measurements of a series of sample specimens, by measuring the quality control sample after measurement of other sample specimen added. As a result, compared to a case where the quality control sample is measured in the form of interruption during measurement of a series of sample specimens, measurement results of all sample specimens can be reported more promptly.

It should be understood that embodiments disclosed currently are used by way of example only and do not constitute a limit of their invention. The scope of the present invention is not limited to the description of above-mentioned embodiments, but is defined by the appended claims, and meanings of equivalence with appended claims and all changes that come within the scope are intended to be embraced therein.

For example, in the above-mentioned first embodiment, although an instance, where the present invention is applied to the gene amplification and analysis system composed of the gene amplification measuring apparatus and the personal computer, is shown, the present invention is not limited thereto, and the gene amplification measuring apparatus may be used alone, or the gene amplification measuring apparatus may be equipped with functions of the personal computer.

In the second embodiment, although an instance, where the dispensing unit is controlled so as to dispense the quality control sample after the sample specimen is dispensed, is shown, the present invention is not limited thereto, and such an alternative may be used that the dispensing unit is controlled to dispense the quality control sample in the sample cup placed on the rack to the cuvette of the reaction plate, prior to dispensing of the sample specimen, based on the position of the quality control sample stored in the ROM. In other words, when the sample specimen and the quality control sample are set in the sample setting unit, the dispensing unit is controlled in such a manner that the quality control sample is first dispensed to the cuvette of the reaction plate, the sample specimen is then dispensed to the cuvette, and the quality control sample is dispensed again to the cuvette. In this case, in addition to reporting of the measurement results of the sample specimen, it is possible to confirm before measurement of the sample specimen if the sample measuring apparatus is functioning normally.

In the first embodiment, although an instance, where the dispensing unit is controlled so as to dispense the quality control sample after all sample specimens subjected to batch processing and the dilution sample are dispensed, is shown, the present invention is not limited thereto, and the dispensing unit may be controlled in such a manner that the quality control sample is first dispensed to the detection cell, the sample specimen and the dilution sample are then dispensed, and the quality control sample is dispensed again to the detection cell.

In the second embodiment, although the specimen holder 230 is fixed and the dispensing unit 210 is movably composed, such an alternative composition may be used that the specimen is moved to the dispensing unit by using a rotary table or the like in lieu of the specimen holder unit.

The foregoing detailed description and accompanying drawings have been provided by way of explanation and illustration, and are not intended to limit the scope of the appended claims. Many variations in the presently preferred embodiments illustrated herein will be obvious to one of ordinary skill in the art, and remain within the scope of the appended claims and their equivalents.

What is claimed is:

1. A sample measuring apparatus comprising:
a sample setting unit on which a plurality of samples are capable of being set, the samples comprising a specimen and a control sample;
a dispensing unit for dispensing the sample set on the sample setting unit;
a measurement sample preparation unit for preparing a measurement sample by mixing the sample dispensed by the dispensing unit and a reagent;
a measuring unit for measuring the measurement sample prepared by the measurement sample preparation unit; and
a control unit for controlling the dispensing unit in such a manner that, when a specimen and a control sample are set on the sample setting unit, the specimen is dispensed to the measurement sample preparation unit and then the control sample is dispensed to the measurement sample preparation unit.

2. The sample measuring apparatus according to claim 1, wherein
the control unit is configured so as to control the dispensing unit in such a manner that, when an additional specimen is set on the sample setting unit on which are set the specimen and the control sample, the control sample is dispensed to the measurement sample preparation unit after dispensing the specimen and the additional specimen to the measurement sample preparation unit.

3. The sample measuring apparatus according to claim 2, wherein
the control unit is configured so as to control the dispensing unit in such a manner that, when an additional specimen is set on the sample setting unit during dispensing operation of the specimen, the additional specimen is dispensed to the measurement sample preparation unit after dispensing the specimen to the measurement sample preparation unit, and the control sample is then dispensed to the measurement sample preparation unit.

4. The sample measuring apparatus according to claim 1, wherein
the control unit is configured so as to control the dispensing unit in such a manner that, the control sample is dispensed to the measurement sample preparation unit, the specimen is then dispensed to the measurement sample preparation unit, and then the control sample is dispensed again to the measurement sample preparation unit.

5. The sample measuring apparatus according to claim 1, further comprising:
input means for inputting information for identifying the specimen and the control sample to be set on the sample setting unit.

6. The sample measuring apparatus according to claim 1, wherein the control unit comprises a memory for storing a position of the control sample to be set on the sample setting unit.

7. The sample measuring apparatus according to claim 1, wherein the control sample is a quality control sample.

8. The sample measuring apparatus according to claim 1, further comprising:
determination means for determining whether a measurement result of a control sample is within a predetermined range; and
indicating means for indicating that a measurement result of a specimen, which is dispensed to the measurement sample preparation unit before the control sample is dispensed to the measurement sample preparation unit, is unreliable, when the determination means determines the measurement result of the control sample is not within the predetermined range.

9. A sample measuring apparatus comprising:
a sample setting unit on which a plurality of samples are capable of being set, the samples comprising a specimen and a control sample;
a dispensing unit for dispensing the sample set on the sample setting unit;
a measurement sample preparation unit for preparing a measurement sample by mixing the sample dispensed by the dispensing unit and a reagent;
a measuring unit for measuring the measurement sample prepared by the measurement sample preparation unit; and
a control unit for controlling the dispensing unit in such a manner that, when a specimen and a control sample are set on the sample setting unit, the control sample is dispensed to the measurement sample preparation unit and then the specimen is dispensed to the measurement sample preparation unit, and after that, the control sample is dispensed again to the measurement sample preparation unit.

10. The sample measuring apparatus according to claim 9, wherein the control unit is configured so as to control the dispensing unit in such a manner that, when an additional specimen is set on the sample setting unit on which the specimen and the control sample are set, the specimen and the additional specimen are dispensed to the measurement sample preparation unit after dispensing the control specimen to the measurement sample preparation unit, and then the control sample is dispensed again to the measurement sample preparation unit.

11. The sample measuring apparatus according to claim 10, wherein the control unit is configured so as to control the dispensing unit in such a manner that, when an additional specimen is set on the sample setting unit during dispensing operation of the specimen, the specimen is dispensed to the measurement sample preparation unit after dispensing the control sample to the measurement sample preparation unit, and after that, the additional specimen is dispensed to the measurement sample preparation unit, and after that, the control sample is dispensed again to the measurement sample preparation unit.

12. The sample measuring apparatus according to claim 9, further comprising:
input means for inputting information for identifying the specimen and the control sample to be set on the sample setting unit.

13. The sample measuring apparatus according to claim 9, wherein the control unit comprises a memory for storing a position of the control sample to be set on the sample setting unit.

14. The sample measuring apparatus according to claim 9, wherein the control sample is a quality control sample.

15. A sample measuring apparatus comprising:
a sample setting unit on which a plurality of samples are capable of being set, the samples comprising a specimen and a control sample;
a dispensing unit for dispensing the sample set on the sample setting unit;
a measurement sample preparation unit for preparing a measurement sample by mixing the sample dispensed by the dispensing unit and a reagent;
a measuring unit for measuring the measurement sample prepared by the measurement sample preparation unit; and
a control unit for controlling the dispensing unit in such a manner that, when a specimen and a control sample are set on the sample setting unit, the specimen is dispensed to the measurement sample preparation unit and then the control sample is dispensed to the measurement sample preparation unit.

16. The sample measuring apparatus according to claim 15, wherein the control unit is configured so as to control the dispensing unit in such a manner that, when an additional specimen is set on the sample setting unit on which the specimen and the control sample are set, the control sample is dispensed to the measurement sample preparation unit after dispensing the specimen and the additional specimen to the measurement sample preparation unit.

17. The sample measuring apparatus according to claim 16, wherein the control unit is configured so as to control the dispensing unit in such a manner that, when an additional specimen is set on the sample setting unit during dispensing operation of the specimen, the additional specimen is dispensed to the measurement sample preparation unit after dispensing the specimen to the measurement sample preparation unit, and after that, the control sample is dispensed to the measurement sample preparation unit.

18. The sample measuring apparatus according to claim 15, further comprising:
input means for inputting information for identifying the specimen and the control sample to be set on the sample setting unit.

19. The sample measuring apparatus according to claim 15, wherein the control unit comprises a memory for storing a position of the control sample to be set on the sample setting unit.

20. The sample measuring apparatus according to claim 15, wherein the control sample is a quality control sample.
